(19) United States
(12) Patent Application Publication
(10) Pub. No.: US 2024/0051897 A1
(43) Pub. Date: Feb. 15, 2024

(54) SYNTHESIS OF COMPLEX 15N-LABELED MOLECULES

(71) Applicant: The Trustees of Columbia University in the City of New York, New York, NY (US)

(72) Inventors: Julia DORSHEIMER, New York, NY (US); Tomislav ROVIS, New York, NY (US)

(21) Appl. No.: 18/359,651

(22) Filed: Jul. 26, 2023

Related U.S. Application Data
(60) Provisional application No. 63/369,475, filed on Jul. 26, 2022.

(51) Int. Cl. C07B 59/00

(52) U.S. Cl. CPC C07B 59/001; C07B 59/002; C07B 2200/05

(57) ABSTRACT

Methods for conversion of a broad range of amines to their ¹⁵N isotopic counterparts and the compounds produced thereby.

### CROSS REFERENCE TO RELATED APPLICATION

The application claims the benefit of and priority to U.S. Provisional Application No. 63/369,475, filed on Jul. 26, 2022, the content of which is hereby incorporated by reference its entirety.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### STATEMENT OF GOVERNMENTAL INTEREST

This invention was made with government support under Grant No. GM125206 awarded by the National Institutes of Health, and the National Science Foundation Graduate Research Fellowship Program. The government has certain rights in the invention.

### BACKGROUND

Stable isotopes such as ²H, ¹³C, and ¹⁵N have important applications in chemistry and drug discovery. During modern drug discovery campaigns, isotopologues of pharmaceutical compounds are synthesized to provide valuable insight into drug metabolism and pharmacokinetics. Additionally, they are used as specialized nuclei in applications such as amino acid labeling and hyperpolarized NMR.

Current methods to install ¹⁵N to a compound are expensive and require multiple catalysis steps. The current technology for obtaining an ¹⁵N labeled compound requires a de novo synthesis of the desired compound, precluding fast and modular diversification of existing medicinally relevant or naturally abundant nitrogen containing compounds for their ¹⁵N counterparts. In addition, some of these examples also result in incomplete labeling. It would be beneficial to have more direct methods for generating ¹⁵N-labeled primary amines.

### SUMMARY

The present disclosure is directed to methods for conversion of a broad range of amines to their ¹⁵N isotopic counterparts and the compounds produced thereby.

In accordance with one aspect, the present application discloses a method for producing a ¹⁵N-labeled compound having an alpha-tertiary amine by activating an alpha-tertiary amine via condensation with an electron-rich aldehyde to generate a redox-active imine, catalyzing the redox-active imine with an excited state photocatalyst to generate an imidoyl radical, modifying the imidoyl radical via beta-scission to generate a tertiary radical, adding a sacrificial oxidant to the tertiary radical to generate a carbocation and trapping the carbocation with an ¹⁵N-labeled nucleophile to yield the ¹⁵N-labeled compound having the alpha-tertiary amine.

In accordance with some embodiments, the alpha-tertiary amine is a pharmaceutical compound, an agricultural compound or an environmental compound.

In accordance with some embodiments, the excited state photocatalyst is an oxidizing iridium photocatalyst.

In accordance with some embodiments, the sacrificial oxidant is potassium persulfate.

In accordance with some embodiments, the ¹⁵N-labeled compound having the alpha-tertiary amine is:

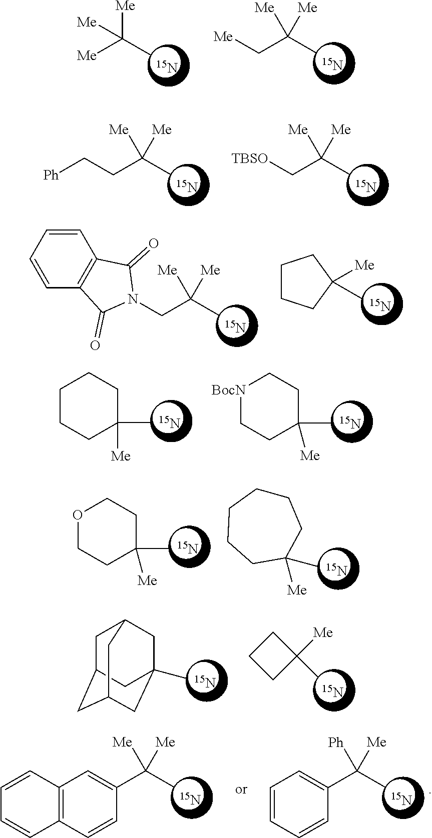

In accordance with some embodiments, the electron-rich aldehyde is 2,4,6-trimethoxybenzealdehyde.

In accordance with some embodiments, the 15N-labeled nucleophile is ¹⁵N-labeled benzophenone imine.

In accordance with some embodiments, the electron-rich aldehyde is 2,4,6-trimethoxybenzealdehyde and the ¹⁵N-labeled nucleophile is ¹⁵N-labeled benzophenone imine.

In accordance with some embodiments, the excited state photocatalyst is an oxidizing iridium photocatalyst, the electron-rich aldehyde comprises 2,4,6-trimethoxybenzealdehyde and the 15N-labeled nucleophile comprises ¹⁵N-labeled benzophenone imine.

In accordance with another aspect, a method for producing a ¹⁵N-labeled compound having an alpha-primary amine or alpha-secondary amine is disclosed. The method includes condensing an alpha-primary amine or alpha-secondary amine with a pyrilium salt to generate a Katritzky pyridinium salt, mixing the Katritzky pyridinium salt and a copper(I) catalyst containing a 1,3-diketone ligand in the presence of a base to generate an electron-donor-acceptor complex, wherein the electron-donor-acceptor complex absorbs blue light, fragmenting the electron-donor-acceptor complex to generate a primary or secondary radical and a Cu(II) species, exchanging a ligand of the Cu(II) species with an ¹⁵N-labeled benzophenone imine and trapping the primary or secondary radical to generate a Cu(III) species and generating the ¹⁵N-labeled compound having the alpha-primary amine or alpha-secondary amine by reductive elimination of the Cu(III) species.

In accordance with some embodiments, the alpha-primary amine or alpha-secondary amine is a pharmaceutical compound, an agricultural compound or an environmental compound.

In accordance with some embodiments, the method also includes irradiating the electron-donor-acceptor complex with light having a wavelength of between about 400 nm and 500 nm. In accordance with some embodiments, the light has a wavelength of about 456 nm.

In accordance with some embodiments, the 1,3-diketone ligand is a tetramethylheptanedianato (TMHD) ligand.

In accordance with some embodiments, the base is cesium carbonate.

In accordance with some embodiments, the ¹⁵N-labeled compound having the alpha-primary amine or alpha-secondary amine is:

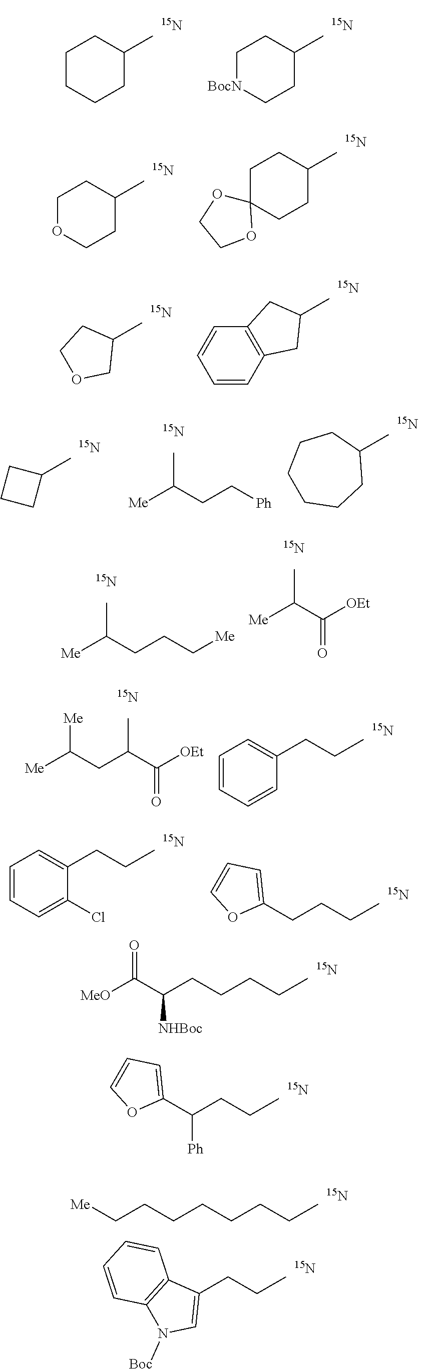

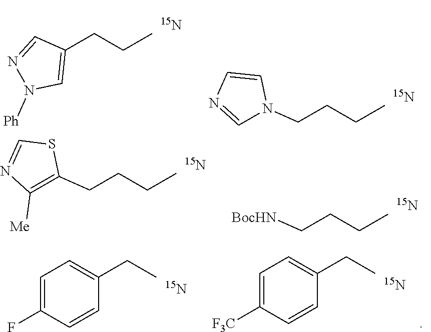

In accordance with some embodiments, the alpha-primary amine or alpha-secondary amine is a furan, indole, pyrazole, imidazole, thiazole or amino acid.

In accordance with another aspect, a method for producing a ¹⁵N-labeled compound having an alpha-primary or alpha-secondary amine is disclosed. The method includes condensing an alpha-primary or alpha-secondary amine with a pyrilium salt to generate a Katritzky pyridinium salt, mixing the Katritzky salt and a copper(I) catalyst containing a tetramethylheptanedianato (TMHD) ligand in the presence of a base to generate an electron-donor-acceptor complex, wherein the electron-donor-acceptor complex absorbs blue light, fragmenting the electron-donor-acceptor complex to generate a primary or secondary radical and a Cu(II) species, exchanging a ligand of the Cu(II) species with an ¹⁵N-labeled nucleophile and trapping the primary or secondary radical to generate a Cu(III) species and generating the ¹⁵N-labeled compound having the alpha-primary or alpha-secondary amine by reductive elimination of the Cu(III) species.

In accordance with some embodiments, the ¹⁵N-labeled nucleophile is ¹⁵N-labeled ammonium chloride.

In accordance one aspect, the present disclosure is directed to ¹⁵N-labeled compounds produced by any of the methods disclosed herein.

### BRIEF DESCRIPTION OF THE FIGURES

One or more of the figures is submitted in color.

FIG. 1 provides a schematic overview of late stage stable ¹⁵N isotope incorporation in accordance with one embodiment.

FIG. 2 provides a schematic overview for activating amines for isotopic-exchange via radical polar crossover in accordance with one embodiment.

FIG. 3 provides a schematic overview of reactions and reaction conditions for isotopic-exchange via radical polar crossover in accordance with one embodiment.

FIG. 4 provides a structures and isolated yields for various ¹⁵N compounds produced in accordance with some embodiments, where (a) depicts NMR yield with mesitylene as an internal standard.

FIG. 5 shows a proposed mechanism for activating amines for isotopic exchange via copper catalysis.

FIG. 6 is a plot showing UV-Vis absorption spectra of Cu(I)Br with TMHD ligand, Katritzky salt A, and all components combined.

FIG. 7 is a schematic showing a redesign of Katritzky salt for α-primary amines.

FIG. 8 is a plot showing UV-Vis absorption spectra of Cu(I)Br with TMHD ligand, Katritzky salts B and C, and all components combined.

FIG. 9 illustrates general reaction conditions for isotopic editing of amines with Cu catalysis in accordance with one embodiment.

FIG. 10 provides representative α-2° amines and isolated yields in accordance with some embodiments.

FIG. 11 provides representative α-1° amines and isolated yields in accordance with some embodiments.

FIG. 12 illustrates general reaction schematic for isotopic editing of drug-like compounds in accordance with one embodiment.

FIG. 13 provides representative ¹⁵N labeled drug-like compounds with isolated yields, where an asterisk depicts an NMR yield with mesitylene as an internal standard in accordance with some embodiments.

### DETAILED DESCRIPTION

In the following description, certain specific details are set forth in order to provide a thorough understanding of various embodiments. However, one skilled in the art will understand that the invention can be practiced without these details. In other instances, well-known structures have not been shown or described in detail to avoid unnecessarily obscuring descriptions of the embodiments.

All definitions, as defined and used herein, should be understood to control over dictionary definitions, definitions in documents incorporated by reference, and/or ordinary meanings of the defined terms. Use of flow diagrams is not meant to be limiting with respect to the order of operations performed for all embodiments. The indefinite articles “a” and “an,” as used herein in the specification and in the claims, unless clearly indicated to the contrary, should be understood to mean “at least one.”

Reference throughout this specification to “one embodiment” or “an embodiment,” etc. means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics can be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

Throughout the present specification, the terms “about” and/or “approximately” can be used in conjunction with numerical values and/or ranges. The term “about” is understood to mean those values near to a recited value. For example, “about 40 [units]” can mean within ±25% of 40 (e.g., from 30 to 50), within ±20%, ±15%, ±10%, ±9%, ±8%, ±7%, ±6%, ±5%, ±4%, ±3%, ±2%, ±1%, less than ±1%, or any other value or range of values herein. Furthermore, the phrases “less than about [a value]” or “greater than about [a value]” should be understood in view of the definition of the term “about” provided herein. The terms “about” and “approximately” can be used interchangeably.

Throughout the present specification, numerical ranges are provided for certain quantities. It is to be understood that these ranges comprise all subranges therein. Thus, the range “from 50 to 80” includes all possible ranges therein (e.g., 51-79, 52-78, 53-77, 54-76, 55-75, 60-70, etc.). Furthermore, all values within a given range can be an endpoint for the range encompassed thereby (e.g., the range 50-80 includes the ranges with endpoints such as 55-80, 50-75, etc.).

Following below are more detailed descriptions of various concepts related to, and embodiments of the compounds and methods disclosed herein. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes. The examples below refer to the use of 2,4,6-trimethoxybenzaldehyde. It should be noted that other electron-rich aldehydes, more specifically electron rich benzaldehydes, which include but are not limited to 2-, 3-, 4-methoxybenzaldehyde; 2,4-, 3,5-, 2,5-dimethoxybenzaldehyde; and 4-ethoxybenzaldehyde could also be used. In place of the TMHD ligand referenced below other 1,3-diketone ligands could also be used. Other bases could be used instead in cesium carbonate including other inorganic carbonates including, but not limited to, lithium carbonate, sodium carbonate, and potassium carbonate.

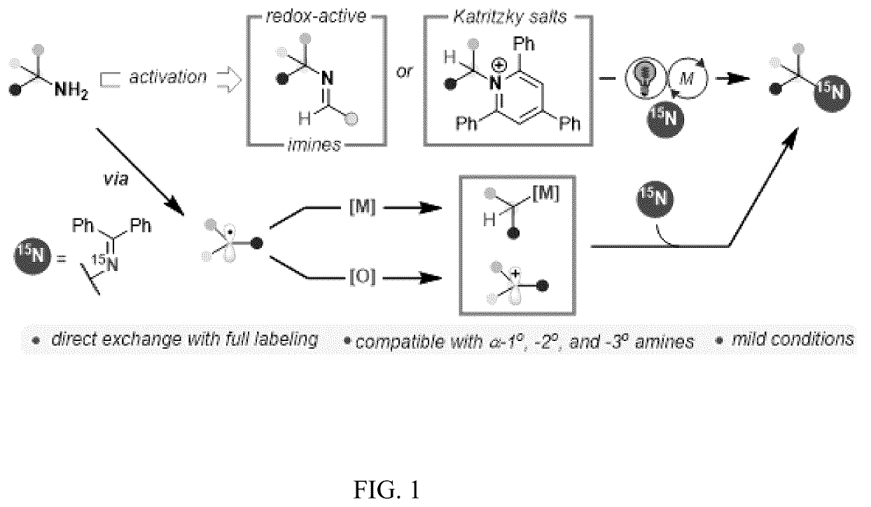

FIG. 1 provides a schematic overview of nitrogen isotope exchange through a deaminative process in accordance with one aspect of the present disclosure. As shown in FIG. 1, [M] represents a metal catalyst, [O] is an oxidant and [¹⁵N] refers to ¹⁵N-benzophenone imine. In accordance with some embodiments, the described process results in direct exchange with full labeling, is conducted under mild conditions and is compatible with α-1°, α-2° and α-3° amines.

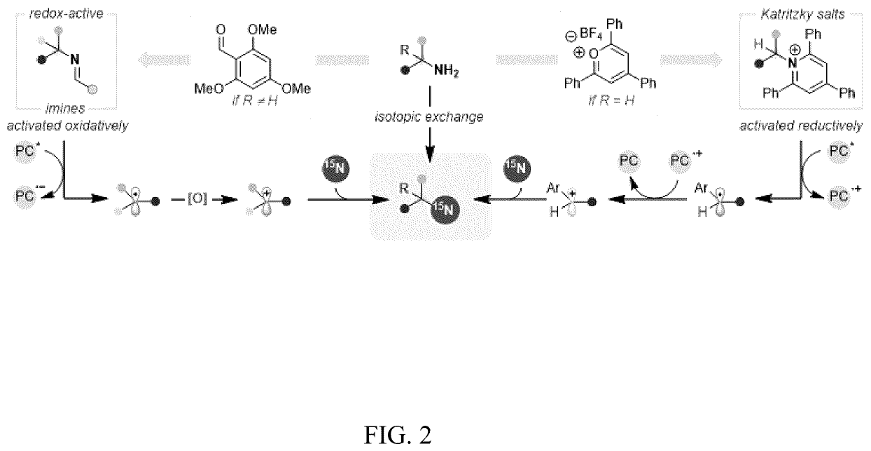

In accordance with some embodiments, single-electron oxidation enables the formation of a tertiary alkyl radical, which are then further oxidized and trapped with a ¹⁵N-labeled nucleophile in a radical-polar-crossover (RPC) mechanism. RPC provides a method for coupling nucleophiles to sterically hindered electrophiles via a carbocation intermediate. See FIG. 2 for general reaction schemes for activating amines for isotopic exchange via radical polar crossover. In accordance with some embodiments, primary amines are activated via formation of either Katritzky salts or redox-active imines.

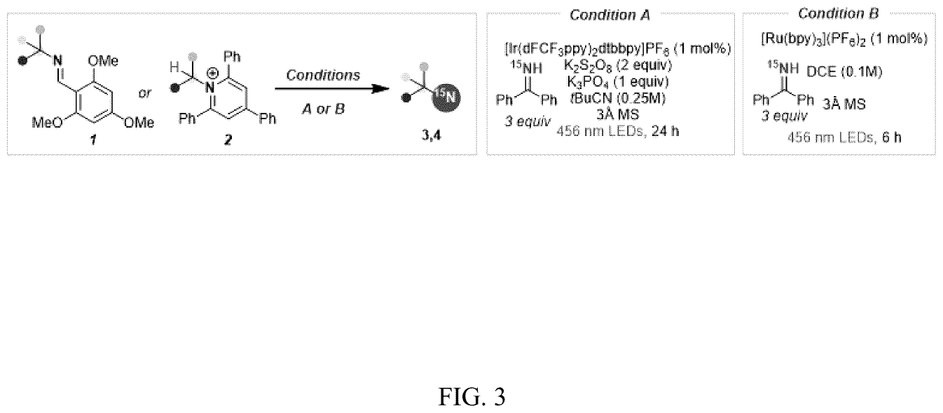

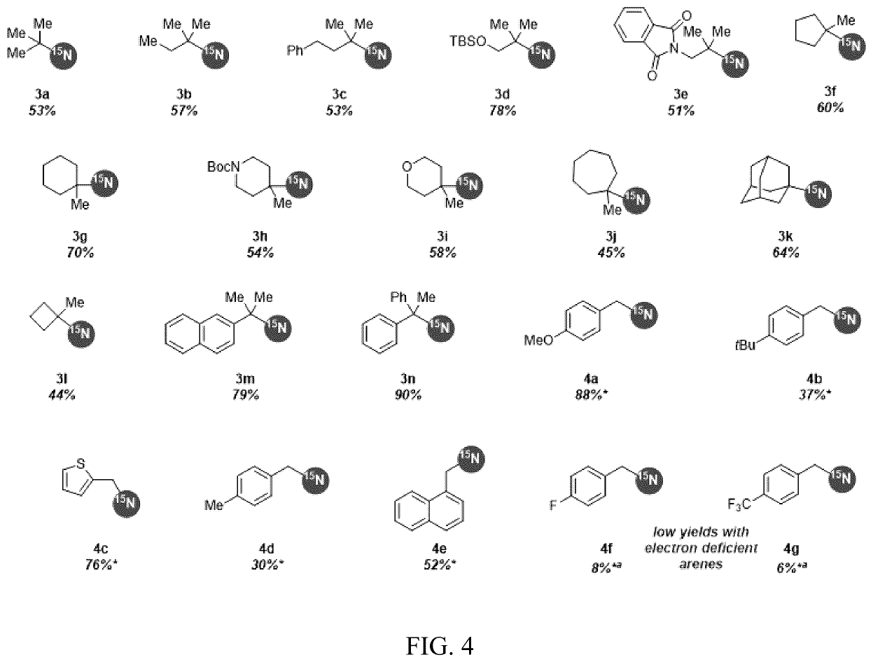

FIG. 3 provides an overview of reactions and reaction conditions for isotopic-exchange via radical polar crossover in accordance with one embodiment. In accordance with one embodiment, the redox-active imines are irradiated with light (e.g., minimum wavelength of about 400 nm and a maximum wavelength of about 500 nm, more particularly around 450 to 460 nm and in some cases around 456 nm) in combination with an oxidizing photocatalyst (e.g., iridium), a sacrificial oxidant (e.g., potassium persulfate), potassium phosphate tribasic, and a ¹⁵N-nucleophile (e.g., ¹⁵N-benzophenone imine) in pivalonitrile. These conditions (Condition A) provide good yields of the desired ¹⁵N-labeled α-3° amines (FIG. 4). FIG. 4 provides structures and yield for various ¹⁵N compounds produced in accordance with some embodiments. The reaction tolerates acyclic α-3° amines (3a-e) with various protected functionalities, such as alcohols (3d) and amines (3e). Cyclic α-3° amines with various ring sizes are also competent coupling partners in the reaction conditions (3f-l). Benzylic α-3° amines (3m, 3n) give higher yields of desired product, likely due to the stability of both the radical and carbocation intermediates, which mitigates undesired reactivity.

Condition B provides for a reducing photocatalyst (e.g., ruthenium) and a ¹⁵N-nucleophile (e.g., ¹⁵N-benzophenone imine), which affords primary benzylic amines in high yields (4a-c). Electron-rich benzylic amines are good coupling partners, while electron neutral ones lead to a drop in yield (4d, 4e) and electron-deficient ones result in trace yields (4f, 4g), likely due to the challenging generation of the carbocation intermediate. In addition, using nonbenzylic Katritzky salts in the RPC system results in trace yields of desired product. Dependence on carbocation stability limited this system to electron-rich α-primary amines.

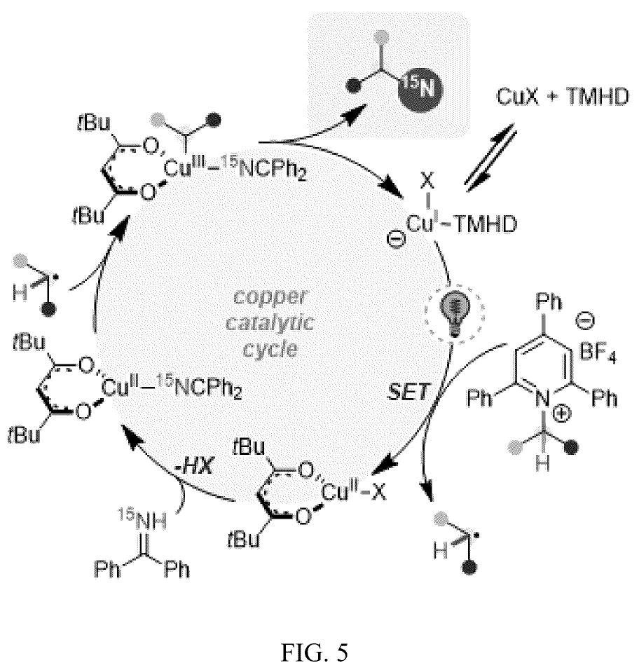

For the compounds in FIG. 4 and FIG. 5, all yields are isolated yields. An asterisk indicates that the reaction was conducted with coupling partner 2 and Condition B. Those compounds in which the yield is marked with an (a), the NMR yield is with respect to mesitylene as an internal standard.

In accordance with another embodiment, isotopic exchange of unactivated α-1° and α-2° amines can be achieved by functionalizing the intermediate radical through a divergent pathway that does not involve carbocation formation. Radicals generated from Katritzky salts interact with a wide variety of electrophilic coupling partners because of the polarity match with the nucleophilic carbon-centered radical. To instead encourage coupling with nucleophilic amine sources, copper catalysis is a viable approach for a C—N cross coupling. In this approach, a photoredox catalyst reduces the Katritzky salt to the corresponding radical, which can be subsequently trapped by a copper catalyst.

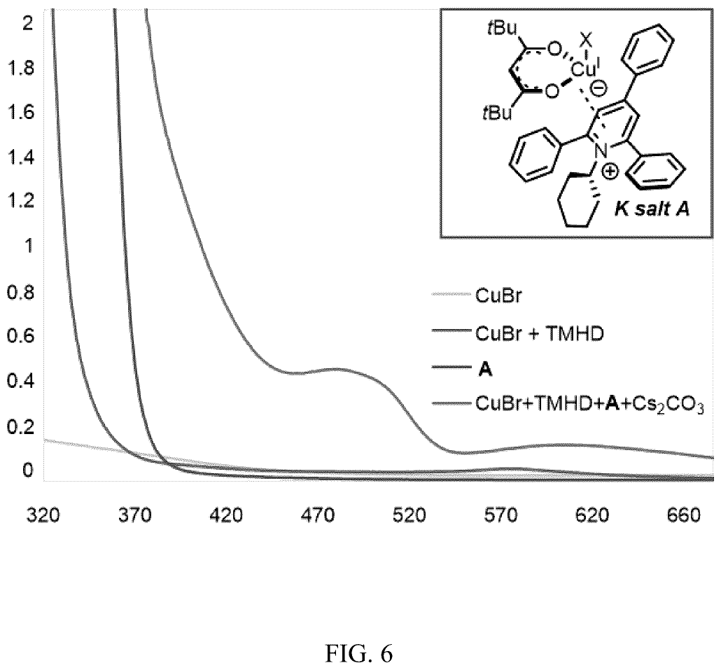

It is proposed that the single-electron transfer event occurs with the copper catalyst and the Katritzky salt through a transiently formed electron donor-acceptor (EDA) complex, enabling formation of the desired radical and the oxidized Cu(II) catalyst (FIG. 5). Ligand exchange and radical trapping (or vice versa) results in the formation of a Cu(III) species that is poised to undergo reductive elimination to yield the desired product. UV-Vis studies confirm that upon mixing the copper catalyst with the Katritzky salt in the presence of base, a new complex is formed, which absorbs light. This complex can then undergo photoinduced single-electron transfer (FIG. 6).

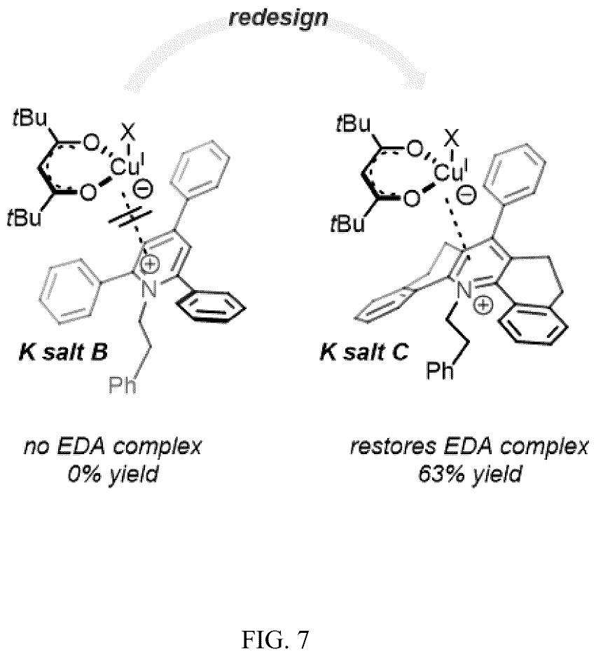

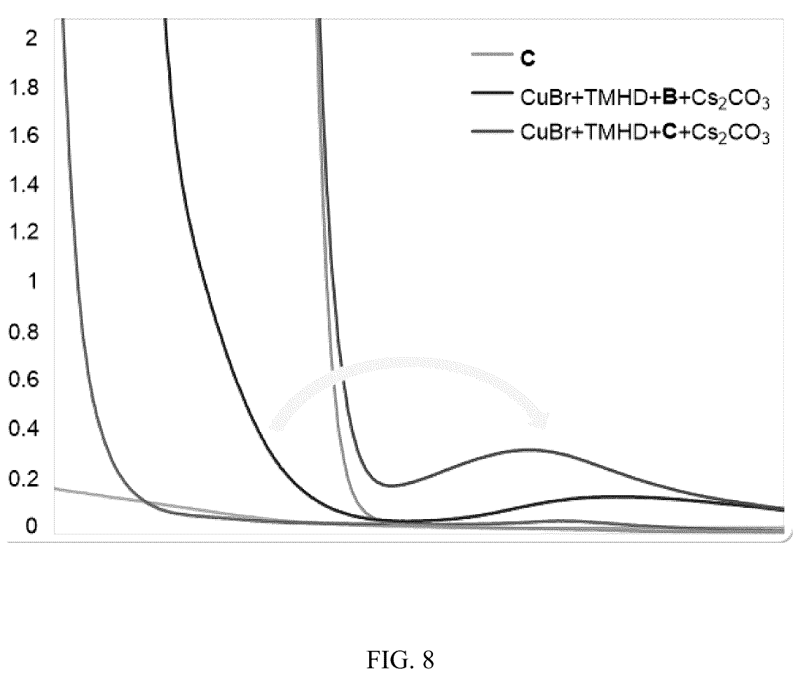

Replacing Katritzky salt A for Katritzky salt B containing an α-1° amine disrupts the EDA complex with a concomitant loss of reactivity (FIG. 7 and FIG. 8). Although not wishing to be bound by theory, it is proposed that this loss of reactivity is attributable to steric differences between the two pyridinium salts. In the case of A, the α-2° amine is twisted out of plane, creating a rigid complex for the copper catalyst to interact with. Conversely, B has more degrees of freedom, possibly affecting the manner in which it interacts with the Cu(I)(TMHD) catalyst. Redesigning the Katritzky salt and installing ethylene bridges between the triphenyl core to rigidify the structure (Katritzky salt C) results in the formation of a new EDA complex while restoring reactivity and yield.

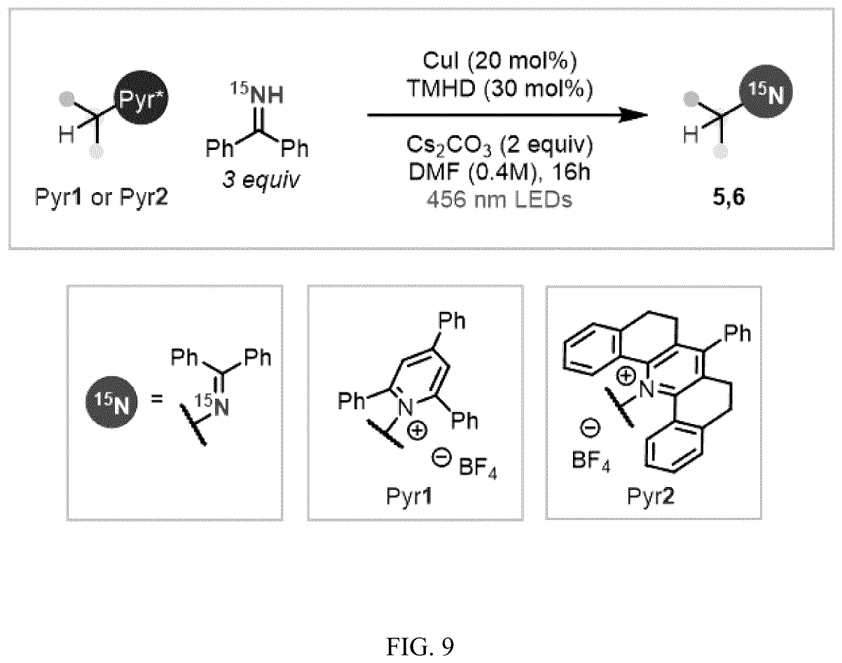

FIG. 9 illustrates general reaction conditions for isotopic editing of amines with Cu catalysis in accordance with one embodiment. Reaction conditions were as follows: 0.25 mmol Pyr1 or Pyr2, 20 mol % CuI, 30 mol % TMHD, 0.50 mmol Cs₂CO₃, 0.75 mmol ¹⁵N-benzophenone imine, 250 mL DMF, 456 nm LED irradiation, 16 hours.

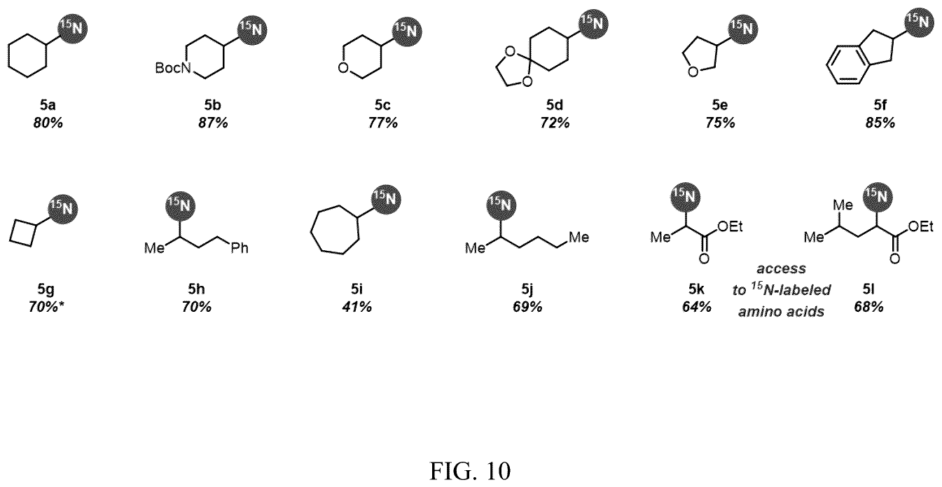

FIG. 10 provides representative α-2° amines and isolated yields in accordance with some embodiments. An asterisk depicts reactions conducted with Pyr2. All yields are isolated yields. Cyclic α-2° amines containing various functionalities provide good yields, including six- (5a-5d), five- (5e, 5f), four- (5g), and seven-membered rings (5h). Linear α-2° amines are also competent coupling partners (5i, 5j). Amino acid motifs (5k, 5l) are successful coupling partners in this transformation, affording valuable ¹⁵N-labeled amino acid derivatives.

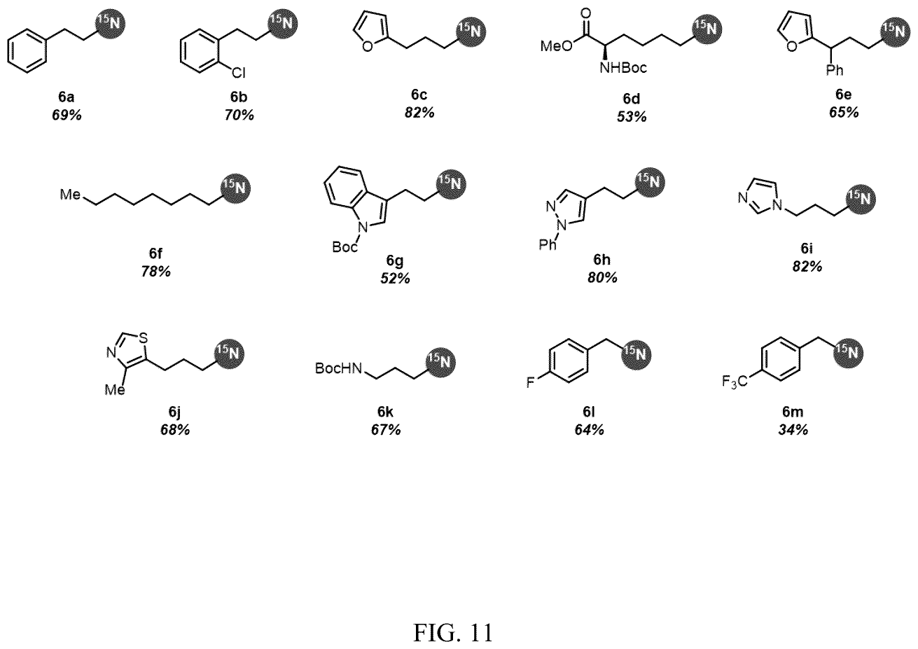

FIG. 11 provides representative α-1° amines and isolated yields in accordance with some embodiments. Utilizing Pyr2 allows for a wide variety of α-1° amines to be utilized for isotopic exchange. Various heterocycles are tolerated, including furans (6c, 6e), indoles (6g), pyrazoles (6h), imidazoles (6i), and thiazoles (6j). Protected lysine 6d undergoes desired coupling efficiently, showcasing the ability to label either nitrogen of this amino acid. Lastly, electron-deficient arenes that were low yielding under the radical-polar crossover conditions can be efficiently converted in the Cu catalytic system (6l, 6m).

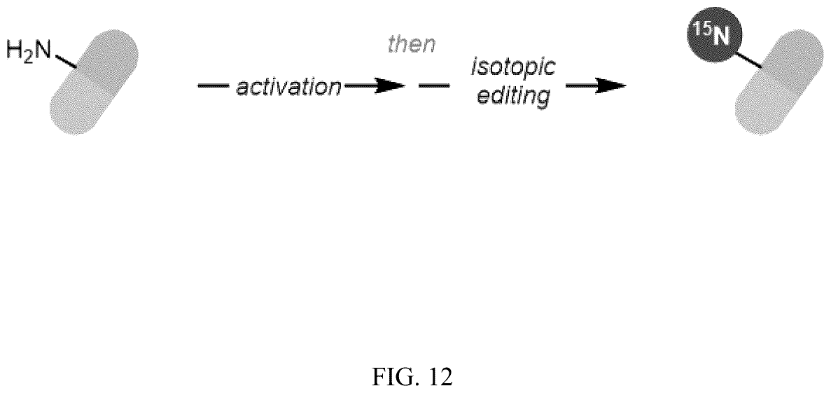

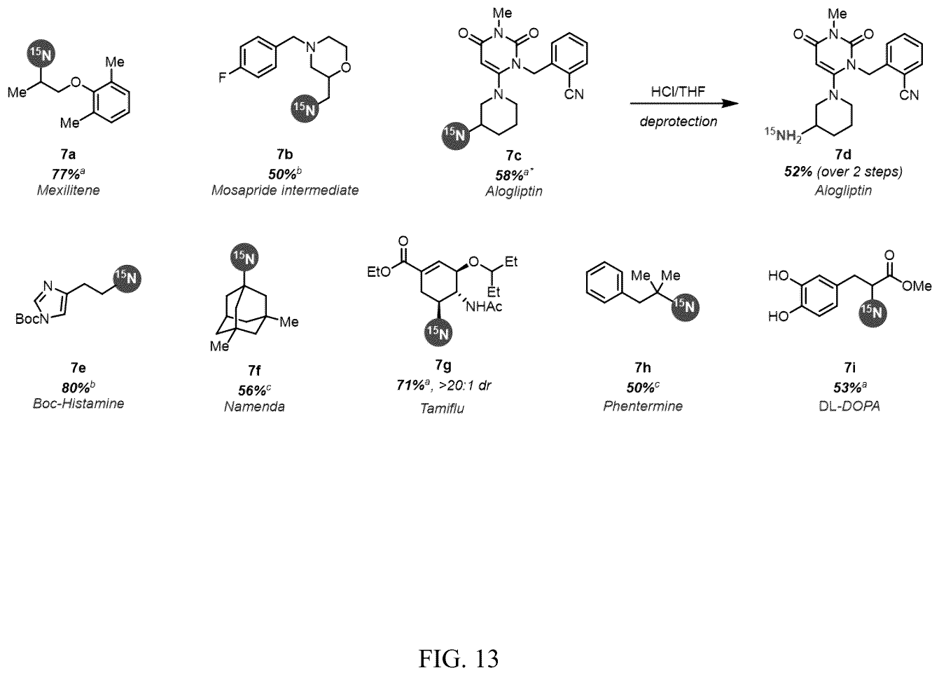

FIG. 12 illustrates general reaction schematic for isotopic editing of drug-like compounds in accordance with certain embodiments. Representative labeled drug-like compounds were produced using one of the following reaction conditions: (a) 1 equiv Pyr1, 20 mol % CuI, 30 mol % TMHD, 2 equiv Cs₂CO₃, 3 equiv ¹⁵N-benzophenone imine, DMF (0.4M), 456 nm LED irradiation for 16 hours; (b) reaction conditions are the same as in (a) but with 1 equiv Pyr2 instead of Pyr1; (c) 1 equiv redox-active imine, 1 mol % [Ir(dFCF₃ppy)dtbbpy]PF₆, 2 equiv potassium persulfate, 1 equiv potassium phosphate tribasic, 3 equiv ¹⁵N-benzophenone imine, ˜25 mg 3 Å MS in pivalonitrile (0.25M) with 456 nm irradiation for 24 hours. The resulting compounds with structures, yield and reaction conditions are provided in FIG. 13. Results marked with an asterisk provide NMR yield with mesitylene as an internal standard.

Amine functionality is one of the most prevalent functional groups in pharmaceutical targets, with primary amines occurring in a variety of market drugs or being used as late-stage intermediates (see 7b) towards substituted amine and amide containing drugs. Installing an isotopic label as the last step in a complex molecule synthesis is particularly useful, as the yield of the isotopically enriched substrate is maximized and there is minimal isotopically labeled waste.

Utilizing α-1° amines such as Mosapride intermediate 7b and Boc-Histamine 7e give the desired product in moderate to good yields. Drug derivatives containing α-2° amines such as Mexilitene 7a, Alogliptin 7c, Tamiflu 7g, and DL-DOPA 7i also give desired isotopic exchange product in synthetically useful yields, while demonstrating the feasibility of deprotection to the primary amine (7d). In addition, α-3° amines such as Namenda 7f and Phentermine 7h also perform well in the isotopic exchange.

The present disclosure provides general methods for the synthesis of ¹⁵N-labeled primary amines. By condensing α-1° and α-2° amines to the Katritzky pyridinium salt and α-3° amines to redox-active imines, the present disclosure provides isotopic-exchange conditions suitable for all three categories of primary alkyl amines The reaction tolerates a variety of functionality and is amenable to the isotopic exchange of late-stage drug derivatives.

The ¹⁵N labeled compounds produced in accordance with the present disclosure can be used to track changes to a system over time, including environmental, agricultural, and pharmaceutical research applications. As used herein, the term “agricultural compound” refers to a compound used in agriculture or found in an agricultural setting. The term “environmental compound” refers to a compound found in the environment or at risk of being introduced to the environment. The isotopic compound has implications in mechanistic studies, amino acid labeling, hyperpolarization probes, and labels in clinical pharmacology. More specifically and by way of example, the compounds can be used as a quantitative tool to research: agriculture fertilizer leaching, bioavailability of a drug, paleoenvironmental studies, neonatal nutrition, atmospheric pollution, nuclear magnetic resonance (NMR), authenticity tagging of drugs, and fuel. Furthermore, since amines are present in all amino acids and nucleotides, the compounds produced in accordance with certain embodiments of the present application could be applied to diverse applications including applications to heavy label amino acids for pharmaceutical study or to fertilizers to assess the role of climate change and leaching on soil health. The ¹⁵N labeled compounds produced in accordance with the present disclosure can be used to analyze exposure to chemicals, environmental pollutants and other substances. They can also be used to trace environmental pollutants from origin to final disposition and to analyze chemical reactions in various systems including natural environments.

### Examples

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Synthesis of Compounds

### 2. Starting Material Synthesis

### Synthesis of ¹⁵N-Benzophenone Imine

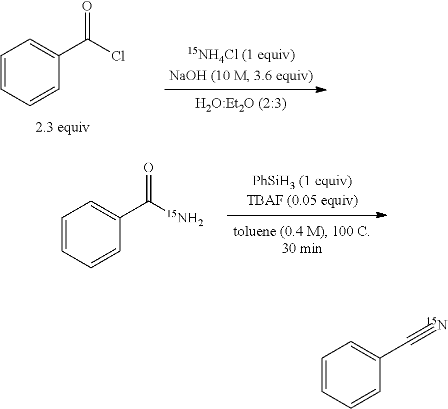 [SMILES: O=C(Cl)c1ccccc1 ; [15NH2]C(=O)c1ccccc1 ; [15N]#Cc1ccccc1]

Synthesis of ¹⁵N-benzamide: No precautions with respect to air were taken. To a 150 mL round bottom flask was added ¹⁵N-ammonium chloride (2.0 g, 1 equiv), H₂O (8 mL), Et₂O (12 mL), and benzoyl chloride (9.80 mL, 2.3 equiv). The solution was cooled to 0° C., to which a 10M NaOH solution (also pre-cooled to 0° C., 13.2 mL, 3.6 equiv) was added dropwise via addition funnel. The solution was stirred for 5 minutes at 0° C. and 5 minutes at room temperature, then filtered. The solid was washed with Et₂O and dried to give 4.196 g of a white solid (94%). Spectra matches that in the literature. (Ma, Y. et al. Enediolate-Dilithium Amide Mixed Aggregates in the Enantioselective Alkylation of Arylacetic Acids: Structural Studies and a Stereochemical Model. J. Am. Chem. Soc. 135, 16853-16864 (2013)).

Synthesis of ¹⁵N-benzonitrile: To a flame-dried 100 mL round bottom three-neck flask was added ¹⁵N-benzamide (3.0 g, 1 equiv). The flask was evacuated and backfilled with Ar (3×). Phenylsilane (3.028 mL, 1 equiv) and toluene (40 mL) were added to the flask. An outlet was inserted into a septum of three neck flask under positive Ar pressure, followed by dropwise addition of TBAF (1.228 mL, 1.0 M in THF). A large gas formation is observed. Once gas extrusion has slowed, the mixture was heated to 100° C. for 30 minutes. The mixture was concentrated in vacuo (rotovap bath temp=30° C.) and then purified by silica gel chromatography to yield 2.032 g (79%) of a light yellow oil. Spectra matches that in the literature. (Yu, et al., Oxadiazolone-Enabled Synthesis of Primary Azaaromatic Amines. Org. Lett. 18, 5412-5415 (2016)).

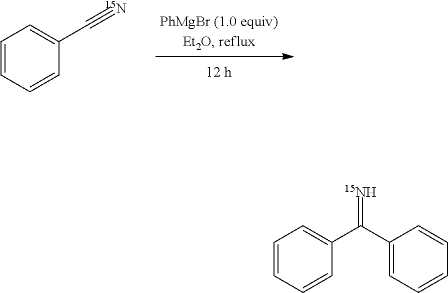 [SMILES: [15N]#Cc1ccccc1 ; [15NH]=C(c1ccccc1)c1ccccc1]

To a flame-dried 100 mL round bottom flask under Ar was added Et₂O (9.5 mL) and PhMgBr (4.786 mL, 3.0 M in Et₂O, 1 equiv). To this mixture was added a solution of ¹⁵N-benzonitrile (1.495 g, 1 equiv) in 7 mL of Et₂O dropwise. The resulting mixture was heated to reflux overnight. The heating bath was removed, and methanol (6 equiv) was added slowly, while an intensive heat formation was observed. The slurry was stirred for another two hours, then filtered. The filter cake was washed with Et₂O, and the filtrate was evaporated to give a light orange oil. The oil was purified via distillation under vacuum (b.p. 116-125 @ 0.5 torr, oil bath temp ˜170 when it first starts distilling) or purification on basic silica (pre-treated with Et₃N) to yield a light yellow oil. Spectra match the literature. (Pintér, et al., Configurationally stable propeller-like triarylphosphine and triarylphosphine oxide. Chem. Commun. 3711-3713 (2007) doi:10.1039/B709655K).

### Synthesis of Redox-Active Imines

The following redox-active imines were synthesized according to previous literature procedures.

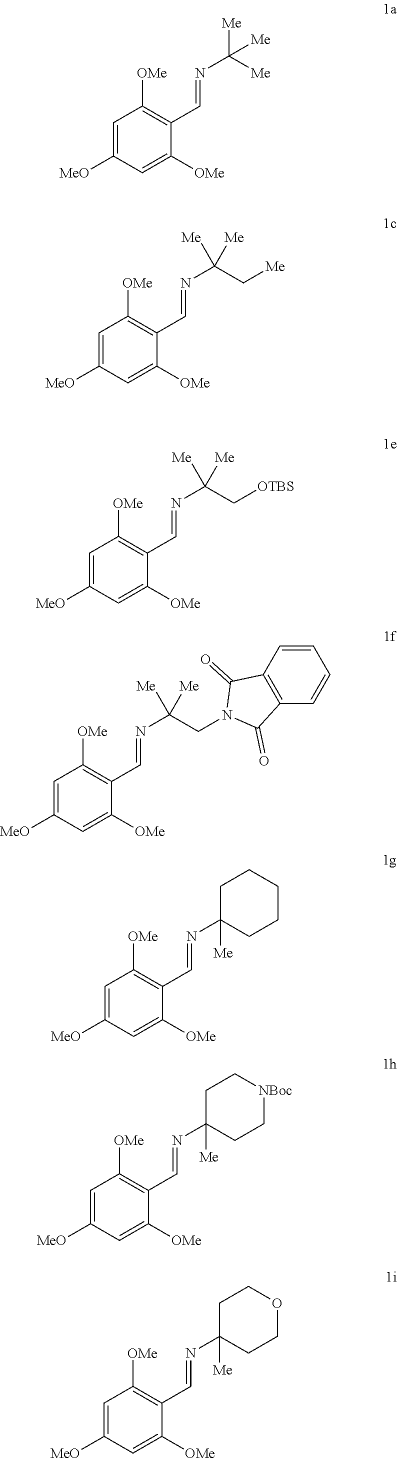

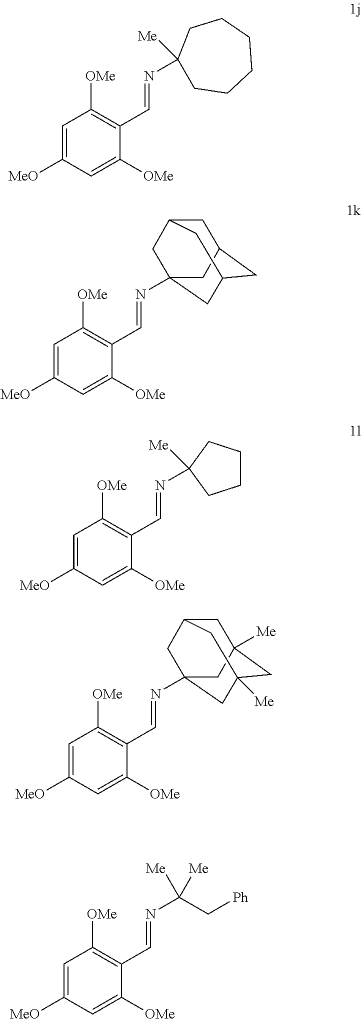

Imines were synthesized according to a modified literature procedure. (Dorsheimer et al., Nickel/Photoredox-Catalyzed Deaminative Cross-Coupling of Sterically Hindered Primary Amines. J. Am. Chem. Soc. 143, 19294-19299 (2021)). A mixture of 2,4,6-trimethoxybenzaldehyde (1.0 equiv.) and primary amine (1.1 equiv. or 2.0 equiv. if volatile) in benzene (0.1M) was heated in a Dean-Stark apparatus to reflux overnight. The reaction was then cooled, dried with Na₂SO₄, filtered, and concentrated in vacuo. Volatile amines were pumped off and/or able to be washed away with hexanes, in which the imine would crash out (additional cooling sometimes required). Imines carried forward without further purification (95-100% purity).

If using an ammonium salt, the following modified procedure is used: The ammonium salt (1.2 equiv) and crushed potassium hydroxide (1.2 equiv) were added to a flask, followed by benzene (0.1M). Three drops of water were added to the flask and stirred for five minutes. Then, 2,4,6-trimethoxybenzaldehyde (1.0 equiv.) was added and heated in a Dean-Stark apparatus to reflux overnight. After cooling to room temperature, hexanes is added to the mixture and is triturated to remove the ammonium hydroxide. The benzene/hexanes solution is concentrated in vacuo to yield pure imine. If excess amine is remaining, hexanes are added and the solution is cooled to either 0° C. or −78° C. and triturated to yield the solid imine.

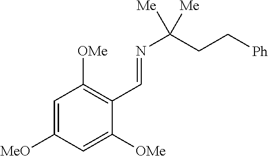 [SMILES: COc1cc(OC)c(/C=N/C(C)(C)CCc2ccccc2)c(OC)c1]

### (1c) N-(2-methyl-4-phenylbutan-2-yl)-1-(2,4,6-trimethoxyphenyl)methanimine

White solid (84%).

¹H NMR (300 MHz, CDCl₃) δ 8.37 (s, 1H), 7.33-7.10 (m, 5H), 6.14 (s, 2H), 3.83 (s, 3H), 3.81 (s, 6H), 2.73-2.62 (m, 2H), 1.97-1.85 (m, 2H), 1.33 (s, 6H).

¹³C NMR (126 MHz, CDCl₃) δ 161.87, 160.11, 151.28, 143.68, 128.42, 128.23, 125.38, 108.94, 90.83, 60.01, 55.92, 55.28, 45.99, 30.76, 27.30.

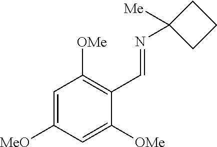 [SMILES: COc1cc(OC)c(/C=N/C2(C)CCC2)c(OC)c1]

### (1l) N-(1-methylcyclobutyl)-1-(2,4,6-trimethoxyphenyl)methanimine

Isolated as an off white solid (40%).

¹H NMR (500 MHz, CDCl₃) δ 8.23 (s, 1H), 6.11 (s, 2H), 3.81 (s, 3H), 3.80 (s, 6H), 2.38-2.23 (m, 3H), 2.12-1.99 (m, 3H), 1.92-1.78 (m, 1H), 1.72 (dtt, J=11.0, 9.6, 2.6 Hz, 1H), 1.40 (s, 3H).

¹³C NMR (126 MHz, CDCl₃) δ 162.11, 160.47, 150.97, 108.36, 90.89, 64.58, 56.12, 55.40, 35.16, 27.87, 13.99.

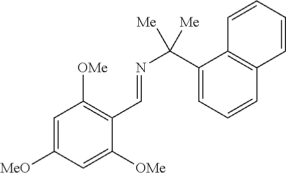 [SMILES: COc1cc(OC)c(/C=N/C(C)(C)c2cccc3ccccc23)c(OC)c1]

### (1m) N-(2-phenylpropan-2-yl)-1-(2,4,6-trimethoxyphenyl)methanimine

Basified first with a NaOH/DCM wash and isolated free amine to subject to condensation. White solid (99%).

¹H NMR (500 MHz, CDCl₃) δ 8.40 (s, 1H), 7.57-7.53 (m, 2H), 7.33 (dd, J=8.4, 7.2 Hz, 2H), 7.22-7.18 (m, 1H), 6.13 (s, 2H), 3.81 (s, 9H), 1.65 (s, 6H).

¹³C NMR (126 MHz, CDCl₃) δ 162.09, 160.33, 152.95, 149.37, 127.89, 126.38, 125.91, 108.82, 90.87, 63.37, 56.00, 55.32, 29.96.

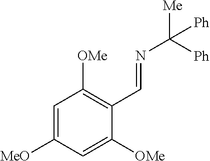 [SMILES: COc1cc(OC)c(/C=N/C(C)(c2ccccc2)c2ccccc2)c(OC)c1]

### (1n) N-(1,1-diphenylethyl)-1-(2,4,6-trimethoxyphenyl)methanimine

White solid (90%).

¹H NMR (500 MHz, CDCl₃) δ 8.04 (s, 1H), 7.47-7.42 (m, 4H), 7.30 (dd, J=8.4, 7.1 Hz, 4H), 7.24-7.17 (m, 2H), 6.12 (s, 2H), 3.82 (s, 3H), 3.81 (s, 6H), 1.98 (s, 3H).

¹³C NMR (126 MHz, CDCl₃) δ 162.32, 160.58, 154.84, 148.35, 128.28, 127.92, 126.24, 108.97, 91.10, 70.47, 56.20, 55.45, 29.67.

### Synthesis of Pyrylium Salts

The pyrylium salts were synthesized according to Cornella's procedure. (Ma, Y. et al., Radical C—N Borylation of Aromatic Amines Enabled by a Pyrylium Reagent. Chem.—Eur. J. 26, 3738-3743 (2020)).

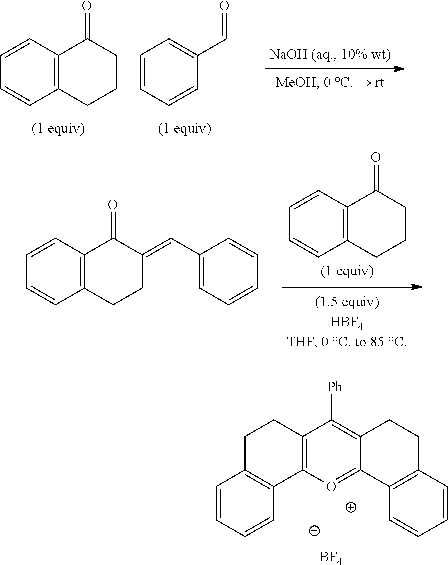

To a round-bottom flask was added α-tetralone (1.0 equiv, 120 mmol), benzaldehyde (1.0 equiv, 120 mmol) and MeOH (0.5 mL/mmol, 60 mL). The reaction system was cooled with an ice bath, to which NaOH aqueous solution (10 wt %, 5 equiv, 600 mL) was added. The ice bath was removed after addition and the mixture was stirred at room temperature until complete conversion was judged by TLC. If corresponding chalcone crushed out during reaction, the crude product was collected by filtration and washed twice with cool MeOH and the product was dried under high vacuum. If the product doesn't precipitate, MeOH was evaporated and EtOAc was used to exact the product. The crude product was taken to the next step without further purification.

To a 100 mL Schlenk flask the corresponding chalcone was charged, then the Schlenk flask was evacuated and refilled with argon three times. The a-tetralone (1.0 equiv, 120 mmol) and anhydrous THE (0.5 mL/mmol, 60 mL) were added successively under argon. The solution was cooled to 0° C. and HBF₄ (1.5 equiv., corresponding Et₂O complex, 180 mmol, 28.116 mL) was added dropwise through an addition funnel under stirring, during which the reaction mixture became dark. The reaction mixture was heated to reflux (temperature of oil bath: 85° C.) for 12 h, during which the pyrylium salt crashed out. After cooling down to room temperature, the pyrylium salt was collected by filtration, washed with Et₂O three times and dried under high vacuum to yield an orange solid (12.9022 g, 24%).

### Synthesis of Pyridinium Salts

The following pyridinium salts have been previously reported.

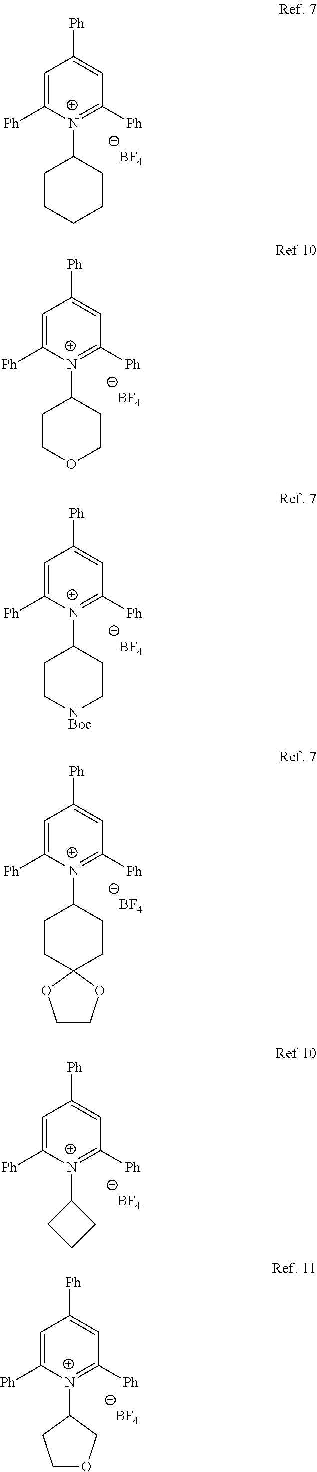

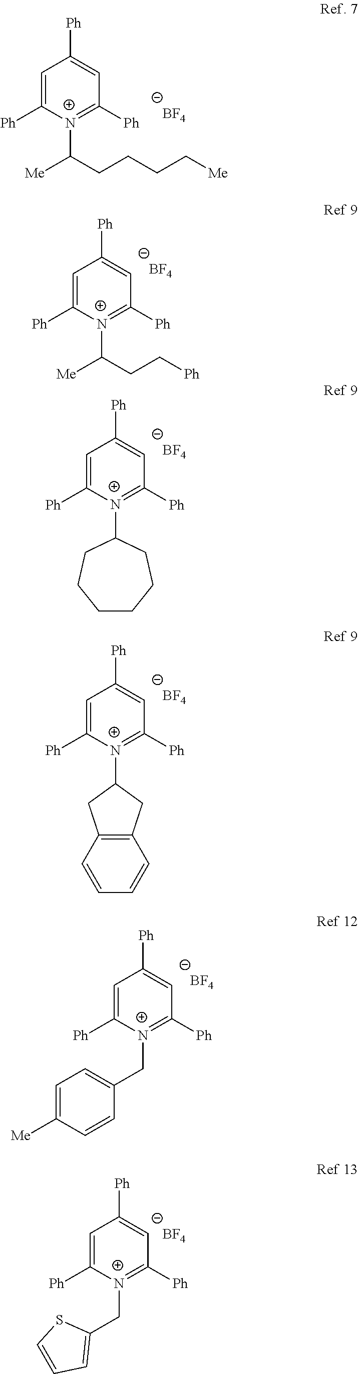

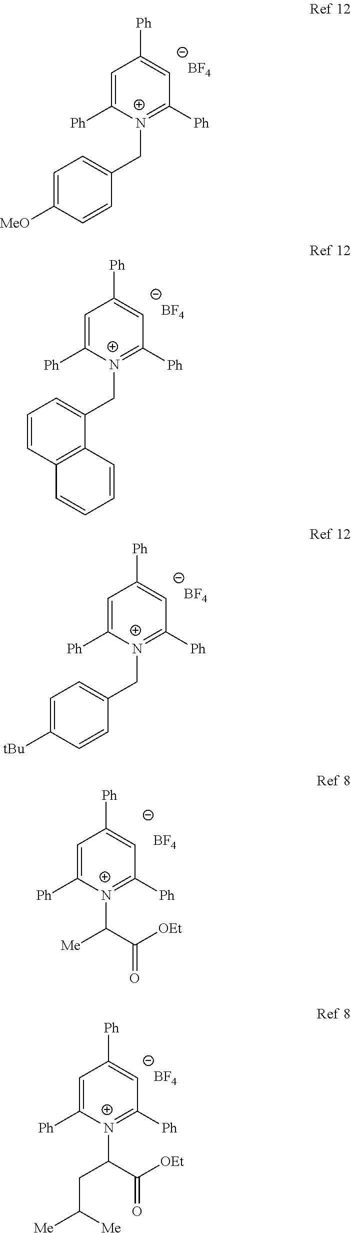

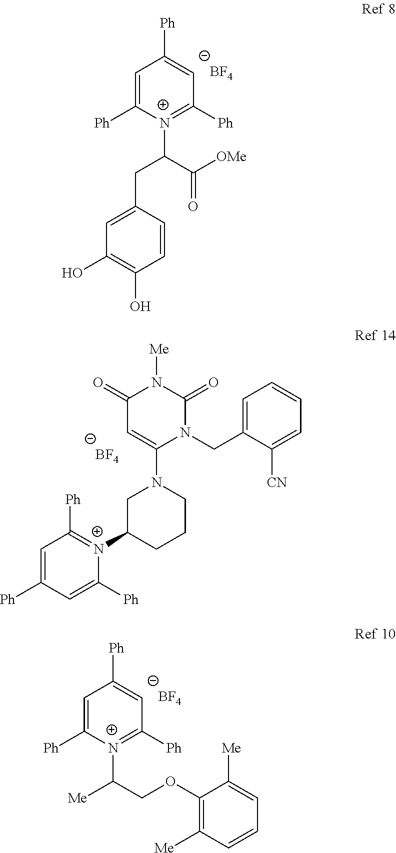

### General Procedure A

Primary amine (1.2 equiv) was added to a suspension of 2,4,6-triphenylpyrylium tetrafluoroborate (1.0 equiv) and EtOH (1.0 M) in a round-bottomed flask. The flask was fitted with a reflux condenser. The mixture was stirred and heated at reflux in an oil bath at 80-85° C. for 4 h. The mixture was then allowed to cool to room temperature. If product precipitation occurred during reflux, the solid was filtered, washed with Et₂O, and dried under high vacuum. If product precipitation did not occur during reflux, the solution was diluted with Et₂O (2-3× volume of EtOH used), sonicated then vigorously stirred for 1 h to induce trituration. The resulting solid pyridinium salt was filtered and washed with Et₂O. If the salt did not precipitate, it was subjected to silica gel chromatography with acetone/DCM.

The corresponding amine hydrochloride salts can also be used using the following modified procedure: Et₃N (1.2 equiv) was added to a mixture of the corresponding alkyl ammonium hydrochloride salt (1.2 equiv) and EtOH (1.0 M). After stirring the mixture for 30 min at room temperature, 2,4,6-triphenylpyrylium tetrafluoroborate (1 equiv) was added. From this point forward, the same procedure was followed as for alkyl amines described above; however prior to washing the solid product with Et₂O, the mixture was washed with water to remove Et₃N·HCl.

### General Procedure B

The a-primary pyridinium salts were synthesized in accordance to a modified literature procedure.¹⁵ The alkyl amine (1.0 equiv.) was added to a suspension of Pyrylium-2 (1.0 equiv.), powdered activated 4 Å molecular sieves (˜500 mg/mmol), and DCM (1 M) in a round-bottomed flask equipped with a stir bar. Acetic acid (1 drop) was added and the mixture was allowed to stir for 4 h at room temperature. The mixture was filtered and subjected to silica gel column chromatography (20% acetone/DCM). Most of the products are yellow and fluorescent and can be monitored via TLC.

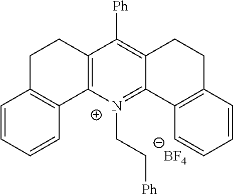

14-phenyl ethyl-7-phenyl-5,6,8,9-tetrahydrodibenzo[c,h]acridin-14-ium tetrafluoroborate: Synthesized according to General Procedure B from 7-phenyl-5,6,8,9-tetrahydrodibenzo[c,h]xanthen-14-ium tetrafluoroborate (400 mg, 0.89 mmol) and commercially available phenylethylamine (0.112 mL, 0.89 mmol). Purified via automated flash to yield a yellow solid (416 mg, 85%).

¹H NMR (500 MHz, CDCl₃) δ 8.44 (dd, J=7.9, 1.2 Hz, 2H), 7.70-7.58 (m, 3H), 7.55-7.45 (m, 4H), 7.38 (dd, J=7.6, 1.3 Hz, 2H), 7.25-7.17 (m, 1H), 7.12 (t, J=7.6 Hz, 2H), 7.00 (dd, J=12.3, 7.1 Hz, 2H), 6.60-6.55 (m, 2H), 5.84-5.78 (m, 2H), 2.72 (dt, J=11.4, 3.2 Hz, 2H), 2.63-2.51 (m, 6H), 2.30-2.14 (m, 2H).

¹³C NMR (126 MHz, CDCl₃) δ 154.85, 153.36, 140.85, 137.09, 135.17, 134.97, 133.01, 130.10, 129.72, 129.62, 129.57, 128.92, 128.77, 128.56, 128.42, 128.21, 127.65, 127.27, 127.16, 65.17, 36.31, 27.73, 26.26.

¹⁹F NMR (376 MHz, CDCl₃) δ −153.11 (¹¹BF₄, minor), −153.16 (¹⁰BF₄, major).

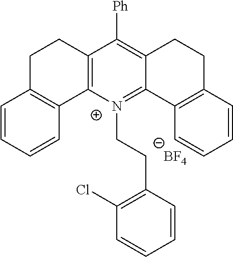

14-(chlorophenethyl)-7-phenyl-5,6,8,9-tetrahydrodibenzo[c,h]acridin-14-ium tetrafluoroborate: Synthesized according to General Procedure B from 7-phenyl-5,6,8,9-tetrahydrodibenzo[c,h]xanthen-14-ium tetrafluoroborate (300 mg, 0.67 mmol) and 2-chlorophenethylamine (0.0942 mL, 0.67 mmol). Purified via automated flash to yield a yellow solid (320 mg, 82%).

¹H NMR (500 MHz, CDCl₃) δ 8.40 (dd, J=7.9, 1.1 Hz, 2H), 7.69-7.59 (m, 3H), 7.55-7.44 (m, 4H), 7.36 (dd, J=7.5, 1.2 Hz, 2H), 7.24 (d, J=7.6 Hz, 1H), 7.20-7.12 (m, 2H), 7.08-6.99 (m, 2H), 6.65-6.60 (m, 1H), 5.91 (dd, J=7.0, 5.5 Hz, 2H), 2.73-2.67 (m, 4H), 2.70-2.60 (m, 2H), 2.55 (td, J=15.2, 4.8 Hz, 2H), 2.25 (td, J=15.8, 5.1 Hz, 2H).

¹³C NMR (126 MHz, CDCl₃) δ 155.35, 153.28, 141.27, 137.58, 135.05, 134.40, 133.07, 132.91, 131.04, 130.07, 129.85, 129.70, 129.60, 129.41, 128.72, 128.53, 128.11, 127.37, 127.23, 62.48, 34.94, 27.82, 26.47.

¹⁹F NMR (470 MHz, CDCl₃) δ −153.03 (¹¹BF₄, minor), −153.09 (d, J=2.3 Hz) (¹⁰BF₄, major).

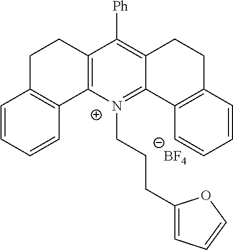

14-(3-(furan-2-yl)propyl)-7-phenyl-5,6,8,9-tetrahydrodibenzo[c,h]acridin-14-ium tetrafluoroborate: Synthesized according to General Procedure B from 7-phenyl-5,6,8,9-tetrahydrodibenzo[c,h]xanthen-14-ium tetrafluoroborate (372 mg, 0.83 mmol) and commercially available 3-(furan-2-yl)propan-1-amine (0.10 mL, 0.83 mmol). Purified via automated flash chromatography (gradient 0->10%->20% DCM/acetone). Yellow solid (190.9 mg, 41%).

¹H NMR (500 MHz, CDCl₃) δ 8.31 (d, J=6.8 Hz, 2H), 7.65-7.57 (m, 3H), 7.57-7.46 (m, 4H), 7.38 (dd, J=7.6, 1.3 Hz, 2H), 7.12 (br s, 1H), 7.06-7.02 (m, 1H), 6.10 (dd, J=3.2, 1.8 Hz, 1H), 5.73-5.68 (m, 1H), 5.41 (t, J=6.9 Hz, 2H), 2.85 (m, 6H), 2.38 (m, 2H), 2.17 (t, J=6.9 Hz, 2H), 1.70 (p, J=6.9 Hz, 2H).

¹³C NMR (126 MHz, CDCl₃) δ 155.44, 153.43, 152.95, 141.18, 141.09, 137.76, 135.24, 132.91, 129.77, 129.64, 129.57, 128.67, 128.48, 128.40, 127.70, 110.42, 106.00, 63.46, 28.56, 28.13, 26.71, 24.44.

¹⁹F NMR (470 MHz, CDCl₃) δ −153.13 (¹¹BF₄, minor), −153.18 (¹⁰BF₄, major).

IR (CDCl₃): 2920.29, 2850.14, 1503.62, 1468.84, 1293.92, 1188.94, 1056.40, 728.97 cm⁻¹.

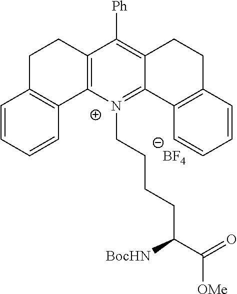

14-(5-((tert-butoxycarbonyl)amino)-6-methoxy-6-oxohexyl)-7-phenyl-5,6,8,9-tetrahydrodibenzo[c,h]acridin-14-ium tetrafluoroborate.

Synthesized according to General Procedure A from 7-phenyl-5,6,8,9-tetrahydrodibenzo[c,h]xanthen-14-ium tetrafluoroborate (233 mg, 0.52 mmol) and commercially available BocLysOMe acetate salt (0.20 g, 0.624 mmol). Purified via flash chromatography using DCM/acetone as a gradient. Yellow solid (248.9 mg, 69%).

¹H NMR (500 MHz, CDCl₃) δ 8.32 (dd, J=8.0, 1.2 Hz, 2H), 7.64 (td, J=7.4, 1.3 Hz, 3H), 7.53 (tt, J=7.4, 2.0 Hz, 5H), 7.40 (dd, J=7.6, 1.3 Hz, 2H), 7.11 (br s, 1H), 5.41-5.31 (m, 2H), 4.94 (m, 1H), 3.98-3.93 (m, 1H), 3.63 (s, 3H), 2.92-2.82 (m, 6H), 2.37 (m, 2H), 1.61 (m, 2H), 1.38 (s, 9H), 1.31 (m, 1H), 0.83 (m, 2H).

¹³C NMR (126 MHz, CDCl₃) δ 172.74, 155.61, 153.40, 141.15, 137.79, 135.22, 132.98, 129.76, 129.63, 129.56, 128.70, 128.61, 128.42, 80.05, 64.42, 53.20, 52.47, 31.81, 31.06, 29.71, 28.42, 28.11, 26.69, 22.22.

¹⁹F NMR (470 MHz, CDCl₃) δ −152.97 (¹¹BF₄, minor), −153.02 (¹⁰BF₄, major).

IR (CDCl₃): 2954.29, 1740.20, 1707.39, 1537.39, 1366.15, 1162.59, 1056.20, 913.99, 772.52, 729.13, 596.80 cm⁻¹.

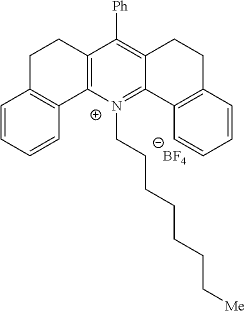

14-(n-octyl)-7-phenyl-5,6,8,9-tetrahydrodibenzo[c,h]acridin-14-ium tetrafluoroborate: Synthesized according to General Procedure B from 7-phenyl-5,6,8,9-tetrahydrodibenzo[c,h]xanthen-14-ium tetrafluoroborate (300 mg, 0.67 mmol) and commercially available octylamine (0.104 mL, 0.67 mmol). Purified via flash chromatography using DCM/acetone as a gradient. Yellow solid (328 mg, 88%).

¹H NMR (500 MHz, CDCl₃) δ 8.40 (dd, J=8.0, 1.1 Hz, 2H), 7.64 (td, J=7.7, 1.3 Hz, 3H), 7.57-7.47 (m, 4H), 7.39 (dd, J=7.6, 1.3 Hz, 3H), 7.13 (s, 1H), 5.38 (t, J=7.0 Hz, 2H), 2.84 (d, J=5.3 Hz, 5H), 2.38 (s, 2H), 1.31 (p, J=7.2 Hz, 2H), 1.20-1.08 (m, 2H), 1.07-0.84 (m, 6H), 0.79 (t, J=7.3 Hz, 3H), 0.71 (ddd, J=14.7, 8.4, 6.3 Hz, 2H).

¹³C NMR (126 MHz, CDCl₃) δ 155.21, 153.48, 140.87, 137.58, 135.10, 132.91, 129.98, 129.63, 128.75, 128.46, 127.59, 64.57, 31.56, 30.07, 28.84, 28.44, 28.18, 26.64, 25.79, 22.56, 14.10.

¹⁹F NMR (470 MHz, CDCl₃) δ −153.29 (¹¹BF₄, minor), −153.35 (¹⁰BF₄, major).

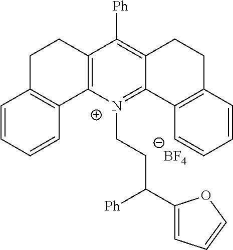

14-(3-(furan-2-yl)3-phenylpropyl)-7-phenyl-5,6,8,9-tetrahydrodibenzo[c,h]acridin-14-ium tetrafluoroborate: Synthesized according to General Procedure B from 7-phenyl-5,6,8,9-tetrahydrodibenzo[c,h]xanthen-14-ium tetrafluoroborate (500 mg, 1.11 mmol) and commercially available 3-(furan-2-yl)-3-phenylpropan-1-amine (223 mg, 1.11 mmol). Purified via automated flash chromatography (DCM/acetone). Yellow solid (387 mg, 55%).

¹H NMR (500 MHz, CDCl₃) δ 8.27 (s, 1H), 8.21 (s, 1H), 7.66 (s, 1H), 7.58-7.50 (m, 4H), 7.47 (t, J=7.5 Hz, 3H), 7.35 (d, J=7.4 Hz, 2H), 7.15-7.04 (m, 5H), 6.84-6.77 (m, 2H), 6.07 (dd, J=3.3, 1.8 Hz, 1H), 5.75 (d, J=3.2 Hz, 1H), 5.48-5.32 (m, 2H), 3.28 (t, J=7.6 Hz, 1H), 2.86-2.77 (m, 5H), 2.35 (s, 2H), 2.19-2.06 (m, 1H), 1.91 (dq, J=14.5, 7.3 Hz, 1H).

¹³C NMR (126 MHz, CDCl₃) δ 155.46, 154.86, 153.57, 153.11, 141.63, 141.02, 140.21, 137.79, 135.15, 132.89, 129.71, 129.63, 128.87, 128.59, 128.45, 128.15, 127.65, 127.30, 127.21, 110.40, 106.38, 62.25, 42.17, 35.01, 28.06, 26.66.

¹⁹F NMR (376 MHz, CDCl₃) δ −152.95 (¹¹BF₄, minor), −153.01 (¹⁰BF₄, major).

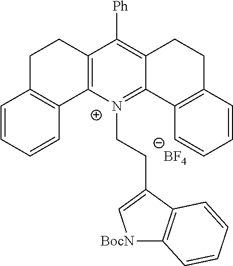

14-(2-(1-(tert-butoxycarbonyl)-1H-indol-3-yl)ethyl)-7-phenyl-5,6,8,9-tetrahydrodibenzo[c,h]acridin-14-ium: Synthesized according to General Procedure B from 7-phenyl-5,6,8,9-tetrahydrodibenzo[c,h]xanthen-14-ium tetrafluoroborate (500 mg, 1.11 mmol) and commercially available tryptamine (179 mg, 1.11 mmol). Purified via automated flash chromatography (DCM/acetone) to yield a yellow solid. This solid (300 mg, 0.51 mmol) was dissolved in MeCN (1 mL), and DMAP (0.62 mmol, 1.2 equiv) and Boc₂O (1.01 mmol, 2 equiv) were added. The reaction was stirred for two hours, then purified via column chromatography to yield an orange solid (272 mg, 77%).

¹H NMR (500 MHz, CDCl₃) δ 8.61 (dd, J=8.0, 1.1 Hz, 2H), 8.19-8.14 (m, 3H), 7.97 (s, 1H), 7.72 (td, J=7.7, 1.3 Hz, 2H), 7.57-7.46 (m, 6H), 7.28-7.17 (m, 1H), 7.04-6.99 (m, 1H), 6.96 (s, 1H), 6.89 (s, 1H), 6.78-6.72 (m, 1H), 6.61-6.56 (m, 2H), 5.98 (t, J=6.1 Hz, 2H), 2.74-2.61 (m, 2H), 2.54 (ddd, J=21.6, 15.5, 4.0 Hz, 4H), 2.20 (td, J=15.7, 4.5 Hz, 2H), 2.11-2.01 (m, 2H), 1.68 (s, 9H).

¹³C NMR (126 MHz, CDCl₃) δ 154.54, 153.25, 149.45, 140.87, 137.05, 135.07, 132.98, 130.04, 129.79, 129.54, 129.47, 128.95, 128.61, 128.40, 127.97, 127.42, 126.97, 125.10, 123.94, 123.21, 118.52, 115.24, 114.07, 84.69, 63.38, 28.35, 27.47, 26.47, 26.27.

¹⁹F NMR (376 MHz, CDCl₃) δ −152.93 (¹¹BF₄, minor), −152.98 (¹⁰BF₄, major).

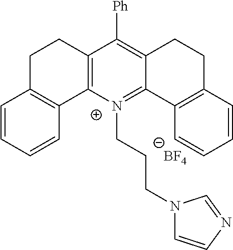

14-(3-(1H-imidazol-1-yl)propyl)-7-phenyl-5,6,8,9-tetrahydrodibenzo[c,h]acridin-14-ium tetrafluoroborate: Synthesized according to General Procedure B from 7-phenyl-5,6,8,9-tetrahydrodibenzo[c,h]xanthen-14-ium tetrafluoroborate (250 mg, 0.56 mmol) and 3-(1H-imidazol-1-yl)propan-1-amine (0.0665 mL, 0.56 mmol). Purified via flash chromatography using DCM/acetone as a gradient. Yellow solid (162.8 mg, 35%).

¹H NMR (500 MHz, CDCl₃) δ 8.08-8.00 (m, 2H), 7.76-7.68 (m, 1H), 7.62 (s, 2H), 7.50 (qt, J=6.9, 3.5 Hz, 6H), 7.42-7.35 (m, 2H), 7.01 (d, J=7.1 Hz, 1H), 6.88-6.78 (m, 2H), 5.30-5.19 (m, 2H), 4.13-4.00 (m, 2H), 3.82 (t, J=6.5 Hz, 2H), 3.11 (t, J=13.6 Hz, 2H), 2.85 (d, J=15.1 Hz, 2H), 2.74 (d, J=13.2 Hz, 2H), 2.30 (t, J=14.0 Hz, 2H), 2.00-1.90 (m, 2H).

¹³C NMR (126 MHz, CDCl₃) δ 156.44, 152.86, 141.93, 138.30, 136.32, 135.33, 132.94, 129.88, 129.44, 129.18, 128.86, 128.51, 128.25, 128.17, 126.93, 126.30, 119.87, 61.16, 44.83, 31.06, 30.77, 29.41, 27.77, 26.72.

¹⁹F NMR (470 MHz, CDCl₃) δ −151.46 (¹¹BF₄, minor), −151.51 (¹⁰BF₄, major).

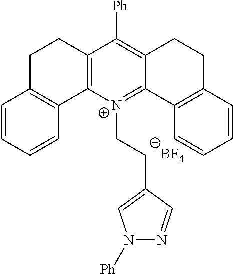

7-phenyl-14-(2-(1-phenyl-1H-pyrazol-4-yl)ethyl)-5,6,8,9-tetrahydrodibenzo[c,h]acridin-14-ium tetrafluoroborate: Synthesized according to General Procedure B from 7-phenyl-5,6,8,9-tetrahydrodibenzo[c,h]xanthen-14-ium tetrafluoroborate (500 mg, 1.11 mmol) and commercially available 2-(1-phenyl-1H-pyrazol-4-yl)ethan-1-amine (207 mg, 1.11 mmol). Purified via automated flash chromatography (DCM/acetone). Yellow solid (518 mg, 85%).

¹H NMR (500 MHz, CDCl₃) δ 8.41 (d, J=7.9 Hz, 2H), 7.70 (td, J=7.7, 1.4 Hz, 2H), 7.57-7.50 (m, 4H), 7.50-7.40 (m, 6H), 7.36 (d, J=7.5 Hz, 2H), 7.30 (t, J=7.5 Hz, 1H), 7.03 (d, J=6.5 Hz, 2H), 6.94 (s, 1H), 5.74 (t, J=6.3 Hz, 2H), 2.77-2.63 (m, 6H), 2.57 (t, J=6.2 Hz, 2H), 2.30 (d, J=17.6 Hz, 2H).

¹³C NMR (126 MHz, CDCl₃) δ 155.15, 153.35, 141.03, 140.34, 139.55, 137.34, 134.86, 133.00, 129.79, 129.73, 129.53, 129.45, 128.75, 128.67, 128.44, 128.21, 127.31, 127.13, 126.79, 126.26, 118.64, 116.94, 65.43, 27.73, 26.26, 25.65.

¹⁹F NMR (471 MHz, CDCl₃) δ −151.94 (¹¹BF₄, minor), −151.99 (¹⁰BF₄, major).

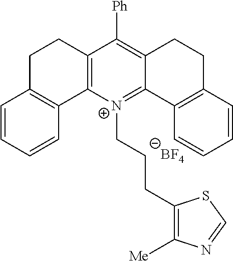

14-(3-(4-methylthiazol-5-yl)propyl)-7-phenyl-5,6,8,9-tetrahydrodibenzo[c,h]acridin-14-ium tetrafluoroborate: Synthesized according to General Procedure B from 7-phenyl-5,6,8,9-tetrahydrodibenzo[c,h]xanthen-14-ium tetrafluoroborate (400 mg, 0.89 mmol) and commercially available 3-(4-methylthiazol-5-yl)propan-1-amine (139 mg, 0.89 mmol). Purified via automated flash chromatography (DCM/acetone). Yellow solid (323 mg, 62%).

¹H NMR (500 MHz, CDCl₃) δ 8.29 (d, J=7.9 Hz, 2H), 7.68-7.56 (m, 4H), 7.56-7.46 (m, 5H), 7.37 (d, J=7.4 Hz, 2H), 7.11 (s, 1H), 6.58 (d, J=1.3 Hz, 1H), 5.53 (t, J=7.2 Hz, 2H), 2.93 (d, J=9.6 Hz, 2H), 2.80 (s, 4H), 2.35 (d, J=15.3 Hz, 2H), 2.21 (s, 3H), 1.84 (p, J=7.0 Hz, 2H).

¹³C NMR (126 MHz, CDCl₃) δ 175.35, 167.84, 155.72, 153.32, 151.33, 150.05, 147.83, 141.26, 137.96, 137.94, 137.88, 135.30, 135.22, 135.09, 132.97, 129.61, 129.59, 129.51, 129.01, 128.88, 128.74, 128.62, 128.56, 128.47, 128.26, 127.93, 127.77, 127.69, 127.59, 127.30, 127.12, 125.40, 121.77, 113.88, 62.82, 51.88, 30.64, 29.69, 28.78, 28.36, 28.22, 27.99, 26.60, 26.44, 26.12, 25.88, 24.60, 16.44, 13.03.

¹⁹F NMR (471 MHz, CDCl₃) δ −152.15 (¹¹BF₄, minor), −152.20 (¹⁰BF₄, major).

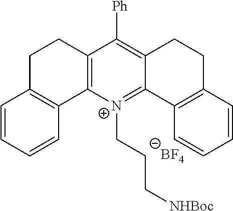

14-(3-((tert-butoxycarbonyl)amino)propyl)-7-phenyl-5,6,8,9-tetrahydrodibenzo[c,h]acridin-14-ium tetrafluoroborate: Synthesized according to General Procedure A from 7-phenyl-5,6,8,9-tetrahydrodibenzo[c,h]xanthen-14-ium tetrafluoroborate (500 mg, 1.11 mmol) and commercially available tert-butyl (3-aminopropyl)carbamate (0.194 mL, 1.11 mmol). Purified via automated flash chromatography (DCM/acetone). Yellow solid (553 mg, 83%).

¹H NMR (500 MHz, CDCl₃) δ 8.17 (dd, J=7.9, 1.3 Hz, 2H), 7.67 (s, 2H), 7.61 (td, J=7.8, 1.5 Hz, 3H), 7.55 (td, J=7.5, 1.2 Hz, 3H), 7.45-7.42 (m, 2H), 7.07 (s, 1H), 5.38 (t, J=7.3 Hz, 2H), 4.95 (s, 1H), 3.10 (dd, J=14.6, 6.6 Hz, 3H), 2.97-2.76 (m, 3H), 2.72 (q, J=6.4 Hz, 2H), 2.36 (s, 2H), 1.59 (p, J=6.7 Hz, 2H), 1.29 (s, 9H).

¹³C NMR (126 MHz, CDCl₃) δ 156.30, 156.00, 153.33, 141.50, 137.91, 135.25, 132.89, 129.47, 129.25, 128.74, 128.42, 128.36, 127.14, 79.01, 62.59, 37.10, 30.78, 28.41, 27.88, 26.61.

¹⁹F NMR (470 MHz, CDCl₃) δ −152.60 (¹¹BF₄, minor), −152.66 (¹⁰BF₄, major).

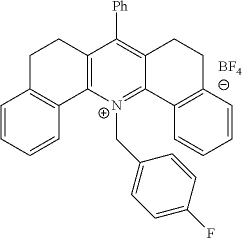

14-(4-fluorobenzyl)-7-phenyl-5,6,8,9-tetrahydrodibenzo[c,h]acridin-14-ium tetrafluoroborate: Synthesized according to General Procedure B from 7-phenyl-5,6,8,9-tetrahydrodibenzo[c,h]xanthen-14-ium tetrafluoroborate (400 mg, 0.89 mmol) and commercially available 4-fluorobenzylamine (0.102 mL, 0.89 mmol). Purified via automated flash chromatography (DCM/acetone). Yellow solid (420 mg, 85%).

¹H NMR (500 MHz, CDCl₃) δ 8.46 (dd, J=7.9, 1.2 Hz, 2H), 7.63 (td, J=7.7, 1.3 Hz, 3H), 7.53 (d, J=7.9 Hz, 3H), 7.42 (td, J=7.5, 1.1 Hz, 2H), 7.23 (dd, J=7.6, 1.3 Hz, 2H), 7.09 (s, 1H), 6.68-6.60 (m, 2H), 6.49-6.41 (m, 2H), 6.30 (s, 2H), 2.78 (d, J=15.7 Hz, 2H), 2.72-2.55 (m, 4H), 2.31 (d, J=17.4 Hz, 2H).

¹³C NMR (126 MHz, CDCl₃) δ 163.25, 161.27, 156.12, 153.98, 141.13, 137.66, 135.28, 134.93, 133.01, 131.03, 131.00, 130.33, 129.63, 129.57, 128.66, 128.26, 128.21, 127.36, 126.09, 115.50 (d, J=21.6 Hz), 67.18, 27.92, 26.40.

¹⁹F NMR (282 MHz, CDCl₃) δ −110.97 (dq, J=8.7, 4.3 Hz), −151.84 (¹¹BF₄, minor), −151.88 (¹⁰BF₄, major).

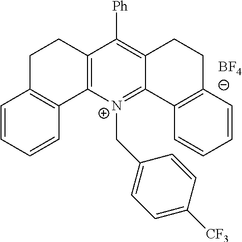

7-phenyl-14-(4-(trifluoromethyl)benzyl)-5,6,8,9-tetrahydrodibenzo[c,h]acridin-14-ium tetrafluoroborate: Synthesized according to General Procedure B from 7-phenyl-5,6,8,9-tetrahydrodibenzo[c,h]xanthen-14-ium tetrafluoroborate (400 mg, 0.89 mmol) and commercially available 4-trifluoromethylbenzylamine (0.126 mL, 0.89 mmol). Purified via automated flash chromatography (DCM/acetone). Yellow solid (426 mg, 79%).

¹H NMR (500 MHz, CDCl₃) δ 8.51 (dd, J=8.0, 1.1 Hz, 2H), 7.65 (td, J=7.7, 1.3 Hz, 3H), 7.54 (t, J=6.8 Hz, 2H), 7.43 (td, J=7.5, 1.1 Hz, 2H), 7.25-7.19 (m, 5H), 7.11 (s, 1H), 6.64 (d, J=8.1 Hz, 2H), 6.45 (s, 2H), 2.80 (s, 2H), 2.69-2.55 (m, 4H), 2.33 (s, 2H).

¹³C NMR (126 MHz, CDCl₃) δ 156.33, 154.06, 141.17, 138.98, 137.79, 134.90, 133.19, 130.37, 129.71, 129.66, 128.79, 128.21, 128.09, 128.00, 127.44, 125.40 (q, J=3.9 Hz), 66.91, 27.90, 26.51.

¹⁹F NMR (282 MHz, CDCl₃) δ −62.08, −151.40 (¹¹BF₄, minor), −151.45 (¹⁰BF₄, major).

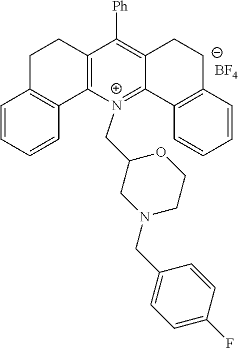

14-((4-(4-fluorobenzyl)morpholin-2-yl)methyl)-7-phenyl-5,6,8,9-tetrahydrodibenzo[c,h]acridin-14-ium tetrafluoroborate: Synthesized according to General Procedure B from 7-phenyl-5,6,8,9-tetrahydrodibenzo[c,h]xanthen-14-ium tetrafluoroborate (400 mg, 0.89 mmol) and commercially available (4-(4-fluorobenzyl)morpholin-2-yl)methanamine (0.175 mL, 0.89 mmol). Purified via automated flash chromatography (DCM/acetone). Yellow solid (422 mg, 72%).

¹H NMR (500 MHz, CDCl₃) δ 8.52 (d, J=7.9 Hz, 1H), 8.36 (d, J=7.9 Hz, 1H), 7.67 (ddd, J=25.5, 12.2, 5.2 Hz, 3H), 7.58-7.46 (m, 4H), 7.38 (t, J=8.5 Hz, 2H), 7.28 (d, J=7.9 Hz, 1H), 7.13 (t, J=4.2 Hz, 1H), 7.09-7.01 (m, 2H), 6.95-6.87 (m, 2H), 5.91 (dd, J=14.8, 3.1 Hz, 1H), 5.11 (dd, J=14.8, 9.9 Hz, 1H), 3.39 (dt, J=11.3, 3.0 Hz, 1H), 3.32 (d, J=13.1 Hz, 1H), 3.28-3.18 (m, 2H), 3.17-3.09 (m, 2H), 2.80 (td, J=15.1, 10.8 Hz, 6H), 2.45-2.26 (m, 4H), 1.87 (ddd, J=12.6, 10.4, 3.2 Hz, 1H), 1.68 (dd, J=11.5, 8.6 Hz, 1H).

¹³C NMR (126 MHz, CDCl₃) δ 163.19, 161.24, 155.62, 155.35, 153.10, 140.97, 140.24, 137.28, 136.41, 135.19, 133.05, 132.92, 132.55, 131.36, 130.78, 130.72, 129.89, 129.68, 129.51, 129.34, 129.29, 129.01, 128.47, 128.41, 128.29, 127.60, 127.45, 115.23 (d, J=21.2 Hz), 73.79, 66.24, 65.75, 61.84, 55.21, 51.66, 29.82, 28.38, 28.09, 26.62, 26.47.

¹⁹F NMR (471 MHz, CDCl₃) δ −114.48, −152.03 (¹¹BF₄, minor), −152.08 (¹⁰BF₄, major).

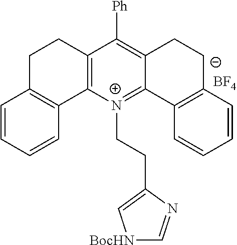

14-(2-(1-(tert-butoxycarbonyl)-1H-imidazol-4-yl)ethyl)-7-phenyl-5,6,8,9-tetrahydrodibenzo[c,h]acridin-14-ium tetrafluoroborate: Synthesized according to General Procedure B from 7-phenyl-5,6,8,9-tetrahydrodibenzo[c,h]xanthen-14-ium tetrafluoroborate (500 mg, 1.11 mmol) and commercially available histamine (123 mg, 1.11 mmol). Purified via automated flash chromatography (DCM/acetone) to yield a yellow solid (450 mg, 75%). Then the Katritzky salt (250 mg, 0.46 mmol) was dissolved in MeCN (1 mL), followed by the addition of DMAP (0.55 mmol, 1.2 equiv) and Boc₂O (0.92 mmol, 2 equiv). The reaction was stirred until starting material was consumed and then purified via column chromatography (DCM/acetone) to yield 226 mg (76%).

¹H NMR (500 MHz, CDCl₃) δ 8.36 (dd, J=7.9, 1.2 Hz, 2H), 7.76 (d, J=1.3 Hz, 1H), 7.63 (td, J=7.7, 1.3 Hz, 2H), 7.52-7.48 (m, 5H), 7.38 (dd, J=7.6, 1.3 Hz, 3H), 7.17-7.06 (m, 2H), 6.80 (d, J=1.3 Hz, 1H), 5.69 (t, J=6.4 Hz, 2H), 2.80-2.67 (m, 6H), 2.57 (t, J=6.3 Hz, 2H), 2.37-2.24 (m, 2H), 1.59 (s, 9H).

¹³C NMR (126 MHz, CDCl₃) δ 155.00, 153.60, 146.74, 141.54, 140.89, 138.10, 137.21, 136.47, 135.27, 132.97, 129.83, 129.57, 128.80, 128.56, 128.46, 114.90, 86.48, 63.78, 28.17, 27.96, 27.84, 26.41.

¹⁹F NMR (376 MHz, CDCl₃) δ −152.53 (¹¹BF₄, minor), −152.58 (¹⁰BF₄, major).

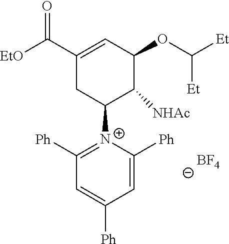

1-((1S,5R,6R)-6-acetamido-3-(ethoxycarbonyl)-5-(pentan-3-yloxy)cyclohex-3-en-1-yl)-2,4,6-triphenylpyridin-1-ium tetrafluoroborate: Synthesized according to General Procedure A from 7-phenyl-5,6,8,9-tetrahydrodibenzo[c,h]xanthen-14-ium tetrafluoroborate (396 mg, 1.0 mmol) and commercially available Tamiflu phosphate (492 mg, 1.2 mmol). Purified via automated flash chromatography (DCM/acetone) to yield a yellow solid (152 mg, 22%).

¹H NMR (500 MHz, CDCl₃) δ 7.94 (d, J=2.4 Hz, 1H), 7.91-7.77 (m, 5H), 7.68 (d, J=6.9 Hz, 2H), 7.63-7.38 (m, 8H), 6.46 (q, J=1.9 Hz, 1H), 5.43 (ddd, J=11.3, 9.2, 7.3 Hz, 1H), 4.41-4.34 (m, 1H), 4.15 (q, J=7.2 Hz, 2H), 3.95 (dt, J=11.3, 7.9 Hz, 1H), 3.27 (p, J=5.8 Hz, 1H), 3.09-2.95 (m, 2H), 1.90 (s, 3H), 1.42-1.29 (m, 4H), 1.26 (t, J=7.1 Hz, 4H), 0.99-0.83 (m, 2H), 0.78 (dt, J=14.4, 7.4 Hz, 6H).

¹³C NMR (126 MHz, CDCl₃) δ 172.77, 165.23, 160.98, 159.56, 155.90, 139.90, 133.45, 133.42, 133.31, 132.95, 132.16, 131.61, 130.53, 130.08, 129.90, 129.79, 128.49, 126.20, 125.86, 83.19, 73.35, 68.89, 61.25, 56.05, 32.31, 26.41, 26.21, 25.82, 23.04, 14.28, 9.60, 9.28, 8.68.

¹⁹F NMR (470 MHz, CDCl₃) δ −150.62 (¹¹BF₄, minor), −150.67 (¹⁰BF₄, major).

### 3. Product Synthesis and Characterization

General Procedure C:

To an oven-dried silicate tube containing a stir bar was added the redox-active imine (1 equiv), [Ir(dFCF₃ppy)₂dtbbpy)]PF₆ (1 mol %), potassium persulfate (2 equiv), and 3 Å molecular sieves (˜25 mg, 3 or 4 balls). The vial was taken to nitrogen glovebox, where potassium phosphate tribasic (1 equiv) was added. Then the vial was brought into a nitrogen wetbox and pivalonitrile (0.25M) was added, followed by ¹⁵N-benzophenone imine (3 equiv). The reaction was sealed with Teflon and taken out of the glovebox, placed in front of one 456 nm light (˜3 cm away) and irradiated for 24 hours. After the reaction, the color should be a light orange. This suspension was filtered over a pad of celite and concentrated in vacuo, then purified by column chromatography or preparatory TLC.

General Procedure D:

To an oven-dried silicate tube containing a stir bar was added the benzylic Katritzky salt (1 equiv), Ru(bpy)₃(PF₆)₂ (1 mol %), and 3 Å molecular sieves (˜25 mg, 3 or 4 balls). The vial was taken to a nitrogen glovebox, where DCE (0.1M) and ¹⁵N-benzophenone imine (3 equiv) were added. The vial was sealed and wrapped with Teflon, then irradiated with one 456 nm Kessil lamp (˜3 cm away) for 6 hours. After completion, the red liquid was concentrated in vacuo and subjected to column chromatography or preparatory TLC.

General Procedure E:

To an oven-dried silicate tube containing a stir bar was added Pyr3 or Pyr4 (1 equiv), CuI (20 mol %), and 3 Å molecular sieves (˜25 mg, 3 or 4 balls). The vial was taken to a nitrogen dry-box, where Cs₂CO₃ (2 equiv) was added. Then, the vial was taken to a nitrogen wet-box and DMF (0.4M) was added. To this solution TMHD (30 mol %) was added and the reaction was stirred for 30 seconds. During this time, the reaction media should turn dark red (for reactions using Pyr3) or dark yellow/red (for reactions using Pyr4). Then, ¹⁵N-benzophenone imine (3 equiv) was added, and the vial was sealed and wrapped in Teflon. The reaction vial was taken out of the glovebox and irradiated by two 456 nm Kessil lamps (˜1 cm away from both lamps) and irradiated for 16 hours. After irradiation, the solids were filtered through celite and rinsed with toluene (4-5× reaction volume). This solution was concentrated in vacuo (rotovap bath temperature: 53° C.), and more toluene was added and concentrated again to remove mostly all DMF. The residue was then subjected to column chromatography or preparatory TLC.

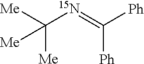 [SMILES: CC(C)(C)[15N]=C(c1ccccc1)c1ccccc1]

(3a) N-tert-butyl-1,1-diphenylmethanimine-¹⁵N: Synthesized according to General Procedure C from N-tert-butyl-1-(2,4,6-trimethoxyphenyl)methanimine (62.8 mg, 0.25 mmol). Purified via preparatory TLC (3% EtOAc/hexanes) to afford 31.2 mg (53%) of a clear oil.

R_{f}: 0.64 (4% EtOAc/hexanes, 1 drop Et₃N).

¹H NMR (400 MHz, CDCl₃) δ 7.42 (dd, J=8.1, 1.7 Hz, 2H), 7.29-7.25 (m, 3H), 7.21-7.13 (m, 3H), 7.10-7.04 (m, 2H), 1.06 (d, J=2.1 Hz, 9H).

¹³C NMR (101 MHz, CDCl₃) δ 163.70, 142.16, 140.06, 132.55, 130.21, 129.44, 128.59, 128.43, 128.20, 128.00, 127.93, 127.59, 127.32, 57.12, 31.73.

¹⁵N NMR (51 MHz, CDCl₃) δ 354.51.

HRMS: ASAP (positive) M=C₁₇H₁₉N¹⁵: calculated (M+H)+m/z 239.1566; found (M+H)+m/z 239.1577.

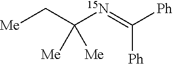 [SMILES: CCC(C)(C)[15N]=C(c1ccccc1)c1ccccc1]

(3b) N-tert-pentyl-1,1-diphenylmethanimine-¹⁵N: Synthesized according to General Procedure C from N-tert-pentyl-1-(2,4,6-trimethoxyphenyl)methanimine (66.3 mg, 0.25 mmol). Purified via preparatory TLC (3% EtOAc/hexanes) to afford 35.6 mg (57%) of a clear oil.

R_{f}: 0.62 (3% EtOAc/hexanes, 1 drop Et₃N).

¹H NMR (500 MHz, CDCl₃) δ 7.57-7.52 (m, 2H), 7.40-7.35 (m, 3H), 7.33-7.27 (m, 3H), 7.21-7.18 (m, 2H), 1.60 (qd, J=7.4, 2.6 Hz, 2H), 1.04 (d, J=1.8 Hz, 6H), 0.97 (t, J=7.4 Hz, 3H).

¹³C NMR (101 MHz, CDCl₃) δ 163.60 (d, J=6.8 Hz), 142.36 (d, J=9.0 Hz), 140.31 (d, J=2.6 Hz), 132.55, 130.21, 129.38, 128.51, 128.42, 128.18, 128.15, 127.98, 127.88, 127.56, 126.58, 59.45 (d, J=2.0 Hz), 38.66 (d, J=4.0 Hz), 28.49, 9.23 (d, J=1.6 Hz).

¹⁵N NMR (51 MHz, CDCl₃) δ 353.58.

HRMS: ASAP (positive) M=C₁₈H₂₁N¹⁵: calculated (M+H)+m/z 254.1756; found (M+H)+ m/z 254.1766.

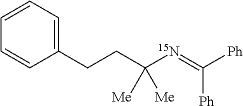 [SMILES: CC(C)(CCc1ccccc1)[15N]=C(c1ccccc1)c1ccccc1]

(3c) N-(2-methyl-4-phenylbutan-2-yl)-1,1-diphenylmethanimine-¹⁵N: Synthesized according to General Procedure C from N-(2-methyl-4-phenylbutan-2-yl)-1-(2,4,6-trimethoxyphenyl)methanimine (82.3 mg, 0.25 mmol). Purified via preparatory TLC (3% EtOAc/hexanes) to afford 43.8 mg (53%) of a clear oil.

¹H NMR (500 MHz, CDCl3) δ 7.60-7.57 (m, 2H), 7.41-7.38 (m, 3H), 7.35-7.27 (m, 5H), 7.25-7.20 (m, 4H), 7.20-7.16 (m, 1H), 2.84-2.77 (m, 2H), 1.95-1.87 (m, 2H), 1.11 (d, J=1.7 Hz, 6H).

¹³C NMR (101 MHz, CDCl₃) δ 163.93 (d, J=6.7 Hz), 143.69, 142.12, 140.11 (d, J=2.8 Hz), 132.55, 130.21, 129.55, 128.58, 128.52, 128.44, 128.23, 128.20, 128.04, 128.03, 127.97, 125.62, 59.16 (d, J=2.0 Hz), 48.74 (d, J=4.3 Hz), 31.40 (d, J=1.7 Hz), 29.85, 28.87.

¹⁵N NMR (51 MHz, CDCl₃) δ 352.04.

HRMS: ASAP (positive) M=C₂₄H₂₅N¹⁵: calculated (M+H)+m/z 330.2069; found (M+H)+m/z 330.2069.

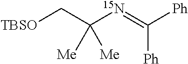 [SMILES: CC(C)(CO[Si](C)(C)C(C)(C)C)[15N]=C(c1ccccc1)c1ccccc1]

(3d) N-(1-((tert-butyldimethylsilyl)oxy)-2-methylpropan-2-yl)-1,1-diphenylmethanimine-¹⁵N: Synthesized according to General Procedure C from N-(1-((tert-butyldimethylsilyl)oxy)-2-methylpropan-2-yl)-1-(2,4,6-trimethoxyphenyl)methanimine (95.2 mg, 0.25 mmol). Purified via preparatory TLC (3% EtOAc/hexanes) to afford 71.7 mg (78%) of a clear oil.

R_{f}: 0.51 (3% EtOAc/hexanes)

¹H NMR (400 MHz, CDCl₃) δ 7.43-7.39 (m, 2H), 7.28-7.24 (m, 3H), 7.19-7.12 (m, 3H), 7.11-7.07 (m, 2H), 3.46 (d, J=1.4 Hz, 2H), 0.88 (d, J=1.7 Hz, 6H), 0.77 (s, 9H), −0.09 (d, J=8.2 Hz, 6H).

¹³C NMR (101 MHz, CDCl₃) δ 164.93 (d, J=6.9 Hz), 142.06 (d, J=8.8 Hz), 140.23 (d, J=2.7 Hz), 130.21, 129.55, 128.90, 128.56, 128.39 (d, J=7.6 Hz), 128.24 (d, J=3.1 Hz), 127.98, 127.86, 127.65 (d, J=1.4 Hz), 127.40, 127.32, 126.60, 73.20 (d, J=8.5 Hz), 60.94, 26.09, 24.99, 18.43 (d, J=6.7 Hz), −5.21.

¹⁵N NMR (51 MHz, CDCl₃) δ 347.28.

HRMS: ASAP (positive) M=C₂₃H₃₃N¹⁵OSi: calculated (M+H)+m/z 369.2380; found (M+H)+m/z 369.2384.

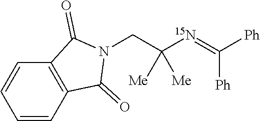 [SMILES: CC(C)(CN1C(=O)c2ccccc2C1=O)[15N]=C(c1ccccc1)c1ccccc1]

(3e) 2-(2-((diphenylmethylene)amino-¹⁵N)-2-methylpropyl)isoindoline-1,3-dione: Synthesized according to General Procedure C from 2-(2-methyl-2-((2,4,6-trimethoxybenzylidene)amino)propyl)isoindoline-1,3-dione (79.2 mg, 0.20 mmol). Purified via preparatory TLC (30% EtOAc/hexanes) to afford 39.1 mg (51%) of a clear oil.

R_{f}: 0.50 (30% EtOAc/hexanes)

¹H NMR (500 MHz, CDCl₃) δ 7.91-7.83 (m, 2H), 7.76-7.68 (m, 2H), 7.56-7.50 (m, 2H), 7.43-7.27 (m, 7H), 7.25-7.18 (m, 2H), 3.88 (d, J=2.5 Hz, 2H), 1.09 (d, J=1.5 Hz, 6H).

¹³C NMR (126 MHz, CDCl₃) δ 169.09, 165.30, 148.14, 141.65, 139.76, 133.96, 132.48, 129.70, 128.50, 128.47, 128.45, 128.32, 128.15, 128.02, 127.97, 127.11, 125.97, 123.34, 61.27, 50.97 (d, J=6.4 Hz), 27.07.

¹⁵N NMR (51 MHz, CDCl₃) δ 344.28.

HRMS: ASAP (positive) M=C₂₅H₂₂N¹⁵NO₂: calculated (M+H)+m/z 385.1763; found (M+H)+m/z 385.1769.

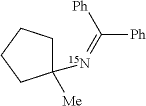 [SMILES: CC1([15N]=C(c2ccccc2)c2ccccc2)CCCC1]

(3f) N-(1-methylcycloheptyl)-1,1-diphenylmethanimine-¹⁵N: Synthesized according to General Procedure C from N-(1-methylcyclopentyl)-1-(2,4,6-trimethoxyphenyl)methanimine (69.2 mg, 0.25 mmol). Purified via preparatory TLC (3% EtOAc/hexanes) to afford 39.4 mg (60%) of a clear oil.

R_{f}: 0.7 (5% EtOAc/hexanes)

¹H NMR (500 MHz, CDCl₃) δ 7.55-7.52 (m, 2H), 7.42-7.36 (m, 3H), 7.34-7.30 (m, 1H), 7.30-7.27 (m, 2H), 7.22-7.19 (m, 2H), 1.82-1.74 (m, 2H), 1.72-1.60 (m, 2H), 1.59-1.43 (m, 4H), 1.12 (d, J=1.6 Hz, 3H).

¹³C NMR (101 MHz, CDCl₃) δ 164.40, 142.04 (d, J=8.5 Hz), 140.22, 130.21, 129.47, 128.67, 128.28, 128.25, 128.01, 128.00, 127.87, 68.06 (d, J=1.7 Hz), 41.76 (d, J=3.1 Hz), 29.85, 26.78, 23.17.

¹⁵N NMR (51 MHz, CDCl₃) δ 353.59.

HRMS: ASAP (positive) M=C₁₉H₂₁N¹⁵: calculated (M+H)+m/z 266.1757; found (M+H)+m/z 266.1750.

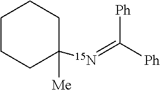 [SMILES: CC1([15N]=C(c2ccccc2)c2ccccc2)CCCCC1]

(3g) N-(1-methylcyclohexyl)-1,1-diphenylmethanimine-¹⁵N: Synthesized according to General Procedure C from N-(1-methylcyclohexyl)-1-(2,4,6-trimethoxyphenyl)methanimine (82.3 mg, 0.25 mmol). Purified via preparatory TLC (3% EtOAc/hexanes) to afford 48.4 mg (70%) of a clear oil.

R_{f}: 0.61 (3% EtOAc/hexanes)

¹H NMR (500 MHz, CDCl₃) δ 7.59-7.55 (m, 2H), 7.39-7.37 (m, 3H), 7.33-7.27 (m, 3H), 7.22-7.19 (m, 2H), 1.76-1.70 (m, 3H), 1.68-1.60 (m, 2H), 1.43 (dtd, J=10.8, 6.3, 3.8 Hz, 2H), 1.34-1.22 (m, 4H), 1.05 (d, J=1.4 Hz, 3H).

¹³C NMR (101 MHz, CDCl₃) δ 163.75 (d, J=6.8 Hz), 142.38, 140.46 (d, J=2.7 Hz), 132.55, 130.21, 129.42, 128.41 (d, J=2.5 Hz), 128.22, 128.18, 128.14, 128.00, 127.93, 127.90, 58.75 (d, J=2.1 Hz), 40.54 (d, J=2.8 Hz), 29.85, 28.44, 26.20, 23.03.

¹⁵N NMR (51 MHz, CDCl₃) δ 353.83.

HRMS: ASAP (positive) M=C₂₀H₂₃N¹⁵: calculated (M+H)+m/z 280.1913; found (M+H)+m/z 280.1919.

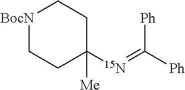 [SMILES: CC1([15N]=C(c2ccccc2)c2ccccc2)CCN(C(=O)OC(C)(C)C)CC1]

(3h) tert-butyl 4-((diphenylmethylene)amino-¹⁵N)-4-methylpiperidine-1-carboxylate: Synthesized according to General Procedure C from tert-butyl-4-methyl-4-((2,4,6-trimethoxybenzylidene)amino)piperidine-1-carboxylate (98 mg, 0.25 mmol). Purified via preparatory TLC (20% EtOAc/hexanes) to afford 50.9 mg (54%) of a clear oil.

R_{f}: 0.7 (20% EtOAc/hexanes)

¹H NMR (500 MHz, CDCl₃) δ 7.59-7.53 (m, 2H), 7.41 (dp, J=4.9, 1.9 Hz, 3H), 7.36-7.32 (m, 1H), 7.29 (dd, J=8.2, 6.5 Hz, 2H), 7.22-7.14 (m, 2H), 3.70 (s, 2H), 3.28 (s, 2H), 1.79-1.71 (m, 2H), 1.45 (s, 9H), 1.43-1.37 (m, 2H), 1.07 (d, J=1.3 Hz, 3H).

¹³C NMR (126 MHz, CDCl₃) δ 165.06 (d, J=6.8 Hz), 155.22, 141.77 (d, J=8.8 Hz), 139.95 (d, J=2.7 Hz), 129.83, 128.27, 128.19, 128.18, 128.09, 128.08, 79.27, 56.89 (d, J=1.9 Hz), 41.23, 39.72, 28.64, 28.08.

¹⁵N NMR (51 MHz, CDCl₃) δ 347.36.

HRMS: ASAP (positive) M=C₂₄H₃₀N¹⁵NO₂: calculated (M+H)+m/z 380.2356; found (M+H)+m/z 380.2366.

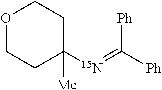 [SMILES: CC1([15N]=C(c2ccccc2)c2ccccc2)CCOCC1]

(3i) N-(4-methyltetrahydro-2H-pyran-4-yl)-1,1-diphenylmethanimine-¹⁵N: Synthesized according to General Procedure C from N-(4-methyltetrahydro-2H-pyran-4-yl)-1-(2,4,6-trimethoxyphenyl)methanimine (58.6 mg, 0.20 mmol). Purified via preparatory TLC (85% pentane, 12% toluene, 3% EtOAc) to afford mg (32.3 mg, 58%) of a clear oil.

R_{f}: 0.30 (85% pentane, 12% toluene, 3% EtOAc)

¹H NMR (500 MHz, CDCl₃) δ 7.60-7.55 (m, 2H), 7.40 (ddd, J=4.4, 2.6, 1.4 Hz, 3H), 7.37-7.33 (m, 1H), 7.32-7.27 (m, 2H), 7.21-7.14 (m, 2H), 3.82 (ddd, J=11.4, 9.8, 2.6 Hz, 2H), 3.68 (dt, J=11.5, 4.2 Hz, 2H), 1.79-1.72 (m, 2H), 1.61-1.51 (m, 2H), 1.12 (d, J=1.4 Hz, 3H).

¹³C NMR (not all aryl resonances shown due to overlap) (126 MHz, CDCl₃) δ 164.80 (d, J=6.7 Hz), 141.87 (d, J=8.9 Hz), 140.08, 129.81, 128.22, 128.17, 128.09, 64.91, 56.34, 40.75 (d, J=2.7 Hz), 29.85, 28.10.

¹⁵N NMR (51 MHz, CDCl₃) δ 349.18.

HRMS: ASAP (positive) M=C₁₉H₂₁N¹⁵O: calculated (M+H)+m/z 281.1672; found (M+H)+m/z 281.1679.

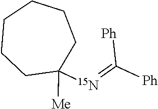 [SMILES: CC1([15N]=C(c2ccccc2)c2ccccc2)CCCCCC1]

(3j) N-(1-methylcycloheptyl)-1,1-diphenylmethanimine-¹⁵N: Synthesized according to General Procedure C from N-(1-methylcycloheptyl)-1-(2,4,6-trimethoxyphenyl)methanimine (76.25 mg, 0.25 mmol). Purified via preparatory TLC (3% EtOAc/hexanes) to afford 32.4 mg (45%) of a clear oil.

R_{f}: 0.68 (5% EtOAc/hexanes).

¹H NMR (500 MHz, CDCl₃) δ 7.58-7.54 (m, 2H), 7.39-7.36 (m, 3H), 7.34-7.27 (m, 3H), 7.20-7.17 (m, 2H), 1.87 (ddt, J=14.3, 8.8, 1.8 Hz, 2H), 1.77-1.55 (m, 4H), 1.49-1.39 (m, 2H), 0.96 (d, J=1.3 Hz, 3H).

¹³C NMR (101 MHz, CDCl₃) δ 162.81 (d, J=6.6 Hz), 142.42, 140.60 (d, J=2.6 Hz), 129.35, 128.49, 128.41, 128.20, 128.17, 127.97, 127.83, 127.63, 62.36 (d, J=2.1 Hz), 44.01 (d, J=3.2 Hz), 29.87, 29.60, 23.48.

¹⁵N NMR (51 MHz, CDCl₃) δ 356.93.

HRMS: ASAP (positive) M=C₂₁H₂₅N¹⁵: calculated (M+H)+m/z 294.2069; found (M+H)+m/z 294.2066.

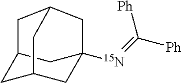 [SMILES: c1ccc(C(=[15N]C23CC4CC(CC(C4)C2)C3)c2ccccc2)cc1]

(3k) N-(adamantan-1-yl)-1,1-diphenylmethanimine-¹⁵N: Synthesized according to General Procedure C from N-(adamantan-1-yl)-1-(2,4,6-trimethoxyphenyl)methanimine (82.3 mg, 0.25 mmol). Purified via preparatory TLC (3% EtOAc/hexanes) to afford 50.1 mg (64%) of a clear oil.

R_{f}: 0.63 (3% EtOAc/hexanes, 1 drop Et₃N).

¹H NMR (500 MHz, CDCl₃) δ 7.57-7.51 (m, 2H), 7.42-7.34 (m, 3H), 7.34-7.23 (m, 3H), 7.21-7.17 (m, 2H), 1.97 (p, J=3.0 Hz, 3H), 1.74 (d, J=2.9 Hz, 6H), 1.63-1.50 (m, 7H).

¹³C NMR (101 MHz, CDCl₃) δ 163.01 (d, J=6.6 Hz), 142.38 (d, J=8.7 Hz), 140.57 (d, J=2.6 Hz), 129.38, 128.49, 128.21, 128.18, 127.98, 127.90, 127.82, 58.16, 44.36 (d, J=1.7 Hz), 36.60, 29.92 (d, J=1.5 Hz).

¹⁵N NMR (51 MHz, CDCl₃) δ 356.00.

HRMS: ASAP (positive) M=C₂₃H₂₄N¹⁵: calculated (M+H)+m/z 319.2103; found (M+H)+m/z 319.2102.

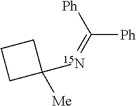 [SMILES: CC1([15N]=C(c2ccccc2)c2ccccc2)CCC1]

(3l) N-(1-methylcyclobutyl)-1,1-diphenylmethanimine-¹⁵N: Synthesized according to General Procedure C from N-(1-methylcyclobutyl)-1-(2,4,6-trimethoxyphenyl)methanimine (52.6 mg, 0.20 mmol). Purified via preparatory TLC (3% EtOAc/hexanes) to afford 21.9 mg (44%) of a clear oil.

R_{f}: 0.67 (5% EtOAc/hexanes).

¹H NMR (500 MHz, CDCl₃) δ 7.56-7.51 (m, 2H), 7.37 (tt, J=3.8, 2.7 Hz, 3H), 7.35-7.27 (m, 3H), 7.23-7.16 (m, 2H), 2.10-2.01 (m, 2H), 1.68-1.62 (m, 2H), 1.56 (dd, J=10.6, 7.8 Hz, 2H), 1.48 (d, J=2.1 Hz, 3H).

¹³C NMR (126 MHz, CDCl₃) δ 163.56, 141.36, 138.94, 131.05, 129.62, 128.78, 128.43, 128.27, 128.07, 127.89, 62.19 (d, J=2.4 Hz), 38.08, 29.85, 26.89, 14.27.

¹⁵N NMR (51 MHz, CDCl₃) δ 350.85.

HRMS: ASAP (positive) M=C₁₈H₁₉N¹⁵: calculated (M+H)+m/z 252.1600; found (M+H)+m/z 252.1608.

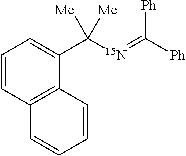 [SMILES: CC(C)([15N]=C(c1ccccc1)c1ccccc1)c1cccc2ccccc12]

(3m) N-(1,1-dimethylnapthyl)-1,1-diphenylmethanimine-¹⁵N: Synthesized according to General Procedure C from N-(1,1-dimethylnapthyl)-1-(2,4,6-trimethoxyphenyl)methanimine (93.8 mg, 0.25 mmol). Purified via preparatory TLC (5% EtOAc/hexanes) to afford 89 mg (90%) of a clear oil.

R_{f}: 0.7 (5% EtOAc/hexanes).

¹H NMR (500 MHz, CDCl₃) δ 8.38-8.33 (m, 1H), 7.78 (dd, J=7.8, 1.8 Hz, 1H), 7.62-7.51 (m, 3H), 7.40 (ddt, J=7.9, 6.8, 5.1 Hz, 3H), 7.34-7.31 (m, 1H), 7.29 (d, J=7.5 Hz, 3H), 7.02-6.93 (m, 2H), 6.85 (dd, J=7.4, 1.2 Hz, 1H), 6.77 (td, J=7.4, 1.2 Hz, 2H), 6.06 (d, J=7.5 Hz, 2H), 1.87 (d, J=2.5 Hz, 6H).

¹³C NMR (126 MHz, CDCl₃) δ 166.08, 145.53, 141.46, 138.00, 134.81, 131.12 (d, J=16.6 Hz), 129.66, 129.16, 129.01, 128.16, 128.06, 127.31, 127.01, 126.65, 125.12, 124.88, 122.87, 62.42, 32.33.

¹⁵N NMR (51 MHz, CDCl₃) δ 350.31.

HRMS: ASAP (positive) M=C₂₆H₂₃N¹⁵: calculated (M+H)+m/z 351.1879; found (M+H)+m/z 351.1885.

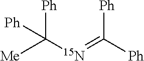 [SMILES: CC([15N]=C(c1ccccc1)c1ccccc1)(c1ccccc1)c1ccccc1]

(3n) N-(1,1-diphenylethyl)-1,1-diphenylmethanimine-¹⁵N: Synthesized according to General Procedure C from N-(1,1-diphenylethyl)-1-(2,4,6-trimethoxyphenyl)methanimine (93.8 mg, 0.25 mmol). Purified via preparatory TLC (3% EtOAc/hexanes) to afford 80.4 mg (90%) of a clear oil.

R_{f}: 0.65 (3% EtOAc/hexanes)

¹H NMR (500 MHz, CDCl₃) δ 7.73-7.67 (m, 2H), 7.41-7.26 (m, 7H), 7.22-7.14 (m, 7H), 7.06 (dd, J=8.4, 7.0 Hz, 2H), 6.56-6.51 (m, 2H), 1.68 (d, J=1.4 Hz, 3H).

¹³C NMR (101 MHz, CDCl₃) δ 166.41, 150.96 (d, J=2.2 Hz), 141.99 (d, J=9.6 Hz), 138.72, 129.77, 128.31, 128.28, 127.93, 127.76, 127.71, 127.51, 127.20, 126.98, 125.83, 29.70, 29.11.

¹⁵N NMR (51 MHz, CDCl₃) δ 350.66.

HRMS: ASAP (positive) M=C₂₇H₂₄N¹⁵: calculated (M+H)+m/z 363.1879; found (M+H)+m/z 363.1870.

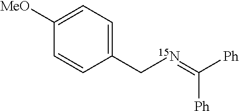 [SMILES: COc1ccc(C[15N]=C(c2ccccc2)c2ccccc2)cc1]

(4a) N-(4-methoxybenzyl)-1,1-diphenylmethanimine-¹⁵N: Synthesized according to General Procedure D from 1-(4-methoxybenzyl)-2,4,6-triphenylpyridin-1-ium tetrafluoroborate (51.5 mg, 0.10 mmol). Purified via preparatory TLC (5% EtOAc/hexanes) to afford 26.6 mg (88%) of a clear oil.

R_{f}: 0.35 (5% EtOAc/hexanes).

¹H NMR (500 MHz, CDCl₃) δ 7.71-7.65 (m, 2H), 7.53-7.41 (m, 3H), 7.40-7.37 (m, 1H), 7.35-7.30 (m, 2H), 7.26-7.19 (m, 4H), 6.90-6.84 (m, 2H), 4.55 (d, J=0.9 Hz, 2H), 3.80 (s, 3H).

¹³C NMR (126 MHz, CDCl₃) δ 168.58 (d, J=5.5 Hz), 158.48, 139.97 (d, J=8.3 Hz), 136.92, 132.98, 130.13, 128.88, 128.69, 128.67, 128.61, 128.42, 128.17, 127.96, 113.92, 57.01, 55.44.

¹⁵N NMR (51 MHz, CDCl₃) δ 322.38.

HRMS: ASAP (positive) M=C₂₁H₁₁₉N¹⁵O: calculated (M+H)+m/z 303.1515; found (M+H)+m/z 303.1520.

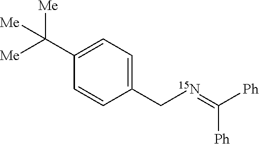 [SMILES: CC(C)(C)c1ccc(C[15N]=C(c2ccccc2)c2ccccc2)cc1]

(4b) N-(4-tertbutylbenzyl)-1,1-diphenylmethanimine-¹⁵N: Synthesized according to General Procedure D from 1-(4-tertbutylbenzyl)-2,4,6-triphenylpyridin-1-ium tetrafluoroborate (108.2 mg, 0.20 mmol). Purified via preparatory TLC (5% EtOAc/hexanes) to afford 24.2 mg (37%) of a clear oil.

R_{f}: 0.65 (5% EtOAc/hexanes).

¹H NMR (500 MHz, CDCl₃) δ 7.72-7.66 (m, 2H), 7.50-7.43 (m, 3H), 7.40-7.31 (m, 4H), 7.28-7.26 (m, 2H), 7.21 (dd, J=8.0, 1.6 Hz, 2H), 4.58 (s, 2H), 1.32 (s, 9H).

¹³C NMR (126 MHz, CDCl₃) δ 168.64, 149.50, 139.99, 137.77, 136.93, 130.17 (d, J=12.1 Hz), 128.70, 128.60, 128.17, 127.99, 127.51, 125.39, 57.31, 31.57.

¹⁵N NMR (51 MHz, CDCl₃) δ 322.08.

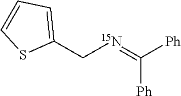 [SMILES: c1ccc(C(=[15N]Cc2cccs2)c2ccccc2)cc1]

(4c) 1,1-diphenyl-N-(thiophen-2-ylmethyl)methanimine-¹⁵N: Synthesized according to General Procedure D from 2,4,6-triphenyl-1-(thiophen-2-ylmethyl)pyridin-1-ium tetrafluoroborate (122.8 mg, 0.25 mmol). Purified via silica gel chromatography with a gradient of 95:5:0 pentane/toluene/Et₂O→90:3:2 pentane/toluene/Et₂O to afford 47.2 mg (68%).

¹H NMR (400 MHz, CDCl₃) δ 7.69 (d, J=7.0 Hz, 2H), 7.59-7.42 (m, 4H), 7.36 (ddd, J=14.5, 7.9, 6.2 Hz, 3H), 7.24-7.14 (m, 3H), 6.96 (dd, J=5.1, 3.4 Hz, 1H), 6.88 (dd, J=2.4, 1.1 Hz, 1H), 4.75 (s, 2H).

¹³C NMR (101 MHz, CDCl₃) δ 169.26 (d, J=5.6 Hz), 157.68, 144.45, 139.66 (d, J=8.3 Hz), 136.51 (d, J=2.5 Hz), 132.55, 130.37, 130.21, 129.24 (d, J=8.3 Hz), 128.86, 128.79, 128.43, 128.23, 127.32 (d, J=5.8 Hz), 126.77, 124.11, 123.62, 117.28, 52.98.

¹⁵N NMR (51 MHz, CDCl₃) δ 319.48.

HRMS: ASAP (positive) M=C₁₈H₁₅N¹⁵S: calculated (M+H)+m/z 280.1006; found (M+H)+m/z 280.1012.

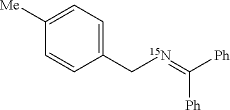 [SMILES: Cc1ccc(C[15N]=C(c2ccccc2)c2ccccc2)cc1]

(4d) N-(4-methylbenzyl)-1,1-diphenylmethanimine-¹⁵N: Synthesized according to General Procedure D from 1-(4-methylbenzyl)-2,4,6-triphenylpyridin-1-ium tetrafluoroborate (49.9 mg, 0.10 mmol). Purified via preparatory TLC (5% EtOAc/hexanes) to afford 26.6 mg (88%) of a clear oil.

R_{f}: 0.51 (5% EtOAc/hexanes).

¹H NMR (500 MHz, CDCl₃) δ 7.73-7.67 (m, 1H), 7.53-7.45 (m, 2H), 7.43-7.38 (m, OH), 7.37-7.33 (m, 1H), 7.25-7.22 (m, 2H), 7.15 (d, J=7.7 Hz, 1H), 4.60 (s, 1H), 2.36 (s, 2H).

¹³C NMR (126 MHz, CDCl₃) δ 168.71, 139.98, 137.76, 136.91, 136.16, 132.56, 130.22, 130.13, 129.15, 128.70, 128.61, 128.43, 128.18, 127.97, 127.73, 57.38, 29.85.

¹⁵N NMR (51 MHz, CDCl₃) δ 300.01.

LRMS: (EI) [C₂₁H₁₉N15]: m/z calculated 286.15; found 286.1.

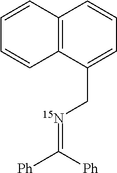 [SMILES: c1ccc(C(=[15N]Cc2cccc3ccccc23)c2ccccc2)cc1]

(4e) N-(naphthalen-1-ylmethyl)-1,1-diphenylmethanimine-¹⁵N: Synthesized according to General Procedure D from 1-(naphthalen-1-ylmethyl)-2,4,6-triphenylpyridin-1-ium tetrafluoroborate (53.5 mg mg, 0.1 mmol). Purified via preparatory TLC (3% EtOAc/hexanes) to afford 16.7 mg (57%) of a clear oil.

¹H NMR (500 MHz, CDCl₃) δ 8.05-8.00 (m, 1H), 7.89-7.84 (m, 1H), 7.76 (s, 1H), 7.73-7.66 (m, 2H), 7.53-7.44 (m, 7H), 7.43-7.36 (m, 1H), 7.28 (d, J=1.8 Hz, 2H), 5.05 (s, 2H).

¹³C NMR (126 MHz, CDCl₃) δ 169.18, 140.00, 136.82, 136.56, 133.87, 131.77, 130.22, 128.78, 128.75, 128.73, 128.42, 128.22, 127.92, 127.49, 127.39, 125.89, 125.75, 125.66, 125.60, 125.36, 125.23, 124.00, 55.40, 29.85.

¹⁵N NMR (51 MHz, CDCl₃) δ 320.53.

LRMS: (EI) [C₂₂H₁₄N15]: m/z calculated 322.15; found 322.1.

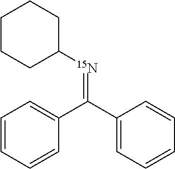 [SMILES: c1ccc(C(=[15N]C2CCCCC2)c2ccccc2)cc1]

(5a) N-cyclohexyl-1,1-diphenylmethanimine-¹⁵N: Synthesized according to General Procedure E from 1-cyclohexyl-2,4,6-triphenylpyridin-1-ium tetrafluoroborate (119.25 mg, 0.25 mmol). Isolated 52.8 mg (80%).

R_{f}: 0.8 (5% acetone/pentane, 1 drop Et₃N).

¹H NMR (500 MHz, CDCl₃) δ 7.58 (d, J=6.6 Hz, 2H), 7.44 (d, J=7.4 Hz, 3H), 7.31 (d, J=7.4 Hz, 3H), 7.16 (dd, J=7.8, 1.7 Hz, 2H), 3.22 (m, 1H), 1.74 (m, 2H), 1.61 (s, 6H), 1.14 (m, 2H).

¹³C NMR (126 MHz, CDCl₃) δ 165.69 (d, J=5.9 Hz), 140.52, 137.60 (d, J=2.7 Hz), 129.70, 128.51 (d, J=2.3 Hz), 128.19, 128.11, 127.83, 61.53, 34.10 (d, J=2.7 Hz), 25.83, 24.56.

¹⁵N NMR (51 MHz, CDCl₃) δ 339.22.

IR (CDCl₃): 3058.82, 3023.84, 2925.91, 2852.36, 1594.22, 1572.19, 1445.74, 1285.66, 1177.45, 964.90, 771.17, 695.23 cm⁻¹.

HRMS: ASAP (positive) M=C₁₉H₂₁N¹⁵: calculated (M+H)+m/z 266.1755; found (M+H)+m/z 266.1774.

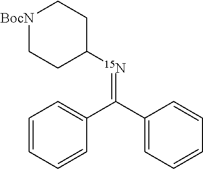 [SMILES: CC(C)(C)OC(=O)N1CCC([15N]=C(c2ccccc2)c2ccccc2)CC1]

(5b) tert-butyl 4-((diphenylmethylene)amino-¹⁵N)piperidine-1-carboxylate: Synthesized according to General Procedure E from 1-(1-(tert-butoxycarbonyl)piperidin-4-yl)-2,4,6-triphenylpyridin-1-ium tetrafluoroborate (144.5 mg, 0.25 mmol). 79.1 mg (87%).

R_{f}: 0.3 (5% acetone/pentane, 1 drop Et₃N).

¹H NMR (500 MHz, CDCl₃) δ 7.59 (m, 2H), 7.50-7.41 (m, 3H), 7.38-7.28 (m, 3H), 7.19-7.12 (m, 2H), 3.99 (br s, 2H), 3.46-3.37 (m, 1H), 2.86 (t, J=11.4 Hz, 3H), 1.73 (m, 2H), 1.58 (m, 2H), 1.46 (s, 9H).

¹³C NMR (126 MHz, CDCl₃) δ 166.74 (d, J=5.5 Hz), 155.08, 140.08 (d, J=8.0 Hz), 137.19 (d, J=3.0 Hz), 130.05, 128.69, 128.54 (d, J=3.0 Hz), 128.46, 128.19, 127.67, 79.44, 58.73, 41.58, 32.98, 28.62.

¹⁵N NMR (51 MHz, CDCl₃) δ 334.07.

IR (CDCl₃): 2974.20, 2927.82, 1858.65, 1688.62, 1608.87, 1420.91, 1364.58, 1233.91, 1169.64, 1133.01, 772.06, 696.54 cm⁻¹.

HRMS: ASAP (positive) M=C₂₃H₂₈O₂N(N¹⁵): calculated (M+H)+m/z 367.2231; found (M+H)+m/z 367.2229.

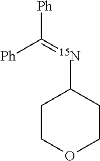 [SMILES: c1ccc(C(=[15N]C2CCOCC2)c2ccccc2)cc1]

(5c) 1,1-diphenyl-N-(tetrahydro-2H-pyran-4-yl)methanimine-¹⁵N: Synthesized according to General Procedure E from 2,4,6-triphenyl-1-(tetrahydro-2H-pyran-4-yl)pyridin-1-ium tetrafluoroborate (120 mg). Purified via column chromotography (2% EtOAc/pentane→10% EtOAc/pentane) to afford 51.1 mg (77%) of a white solid.

R_{f}: 0.17 (5% EtOAc/pentane, 1 drop Et₃N)

¹H NMR (400 MHz, CDCl₃) δ 7.66-7.60 (m, 2H), 7.50-7.43 (m, 3H), 7.34 (ddd, J=12.7, 7.9, 6.1 Hz, 3H), 7.20-7.13 (m, 2H), 4.01 (dt, J=11.5, 3.9 Hz, 2H), 3.50 (dtt, J=9.6, 4.4, 2.9 Hz, 1H), 3.37 (td, J=11.2, 2.4 Hz, 2H), 2.00-1.86 (m, 2H), 1.58 (dd, J=13.2, 3.6 Hz, 2H).

¹³C NMR (101 MHz, CDCl₃) δ 166.82, 139.99 (d, J=8.1 Hz), 137.13, 132.51, 130.16, 130.07, 128.65, 128.57 (d, J=2.9 Hz), 128.47, 128.38, 128.17, 127.66, 66.06 (d, J=1.8 Hz), 58.02, 33.81 (d, J=2.6 Hz).

¹⁵N NMR (51 MHz, CDCl₃) δ 333.99.

HRMS: ASAP (positive) M=C₁₈H₁₉N¹⁵O: calculated (M+H)+m/z 268.1549; found (M+H)+m/z 268.1551.

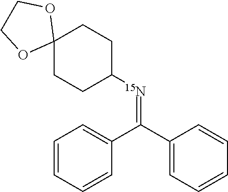 [SMILES: c1ccc(C(=[15N]C2CCC3(CC2)OCCO3)c2ccccc2)cc1]

(5d) 1,1-diphenyl-N-(1,4-dioxaspiro[4.5]decan-8-yl)methanimine-¹⁵N: Synthesized according to General Procedure E from 2,4,6-triphenyl-1-(1,4-dioxaspiro[4.5]decan-8-yl)pyridin-1-ium tetrafluoroborate (133.75 mg, 0.25 mmol). Clear oil (57.7 mg, 72%).

R_{f}: 0.35 (5% EtOAc/pentane, 1 drop Et₃N).

¹H NMR (500 MHz, CDCl₃) δ 7.63-7.58 (m, 2H), 7.49-7.39 (m, 3H), 7.38-7.24 (m, 3H), 7.18-7.13 (m, 2H), 4.00-3.90 (m, 4H), 3.35 (tq, J=8.5, 3.7 Hz, 1H), 1.97-1.81 (m, 4H), 1.70-1.59 (m, 2H), 1.49 (m, 2H).

¹³C NMR (126 MHz, CDCl₃) δ 166.10 (d, J=6.0 Hz), 140.25 (d, J=8.0 Hz), 137.32, 129.83, 128.59, 128.54, 128.29, 128.10, 127.72, 108.76, 64.37, 58.96, 32.40, 31.23.

¹⁵N NMR (51 MHz, CDCl₃) δ 336.25.

IR (CDCl₃): 2931.65, 2870.38, 1609.15, 1444.11, 1285.01, 1144.79, 1099.73, 948.62, 696.41 cm⁻¹.

HRMS: ASAP (positive) M=C₂₁H₂₃O₂N¹⁵: calculated (M+H)+m/z 324.1810; found (M+H)+m/z 324.1816.

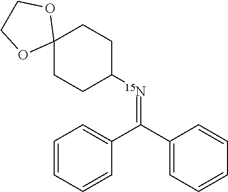 [SMILES: c1ccc(C(=[15N]C2CCC3(CC2)OCCO3)c2ccccc2)cc1]

(5e) 1,1-diphenyl-N-(tetrahydrofuran-3-yl)methanimine-¹⁵N: Synthesized according to General Procedure E from 2,4,6-triphenyl-1-(tetrahydrofuran-3-yl)pyridin-1-ium tetrafluoroborate (116.25 mg, 0.25 mmol). Clear oil (47.5 mg, 75%).

R_{f}: 0.28 (5% EtOAc/pentane, 1 drop Et₃N).

¹H NMR (500 MHz, CDCl₃) δ 7.62 (dt, J=7.1, 1.6 Hz, 2H), 7.52-7.41 (m, 3H), 7.40-7.35 (m, 1H), 7.32 (dd, J=8.3, 6.4 Hz, 2H), 7.17-7.11 (m, 2H), 4.10 (dt, J=8.5, 7.1 Hz, 1H), 4.02 (td, J=6.2, 4.9 Hz, 1H), 3.85 (dt, J=8.4, 6.7 Hz, 2H), 3.81-3.70 (m, 1H), 2.08-2.00 (m, 2H).

¹³C NMR (126 MHz, CDCl₃) δ 167.75 (d, J=6.0 Hz), 139.93-139.66 (m), 137.16, 130.16, 128.68, 128.63, 128.58, 128.19, 127.96, 74.49 (d, J=4.5 Hz), 68.28, 62.11, 35.31.

¹⁵N NMR (51 MHz, CDCl₃) δ 329.33.

IR (CDCl₃): 2970.43, 2940.26, 2860.66, 1610.08, 1571.56, 1444.80, 1285.91, 1074.41, 912.63, 778.80, 696.53 cm⁻¹.

HRMS: ASAP (positive) M=C₁₇H₁₇ON¹⁵: calculated (M+H)+m/z 254.1391; found (M+H)+m/z 254.1398.

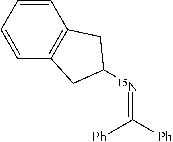 [SMILES: c1ccc(C(=[15N]C2Cc3ccccc3C2)c2ccccc2)cc1]

(5f) N-(2,3-dihydro-1H-inden-2-yl)-1,1-diphenylmethanimine-¹⁵N: Synthesized according to General Procedure #from 1-(2,3-dihydro-1H-inden-2-yl)-2,4,6-triphenylpyridin-1-ium tetrafluoroborate (51.1 mg, 0.1 mmol). Clear oil (25.4 mg, 85%).

R_{f}: (5% EtOAc/pentane, 1 drop Et₃N).

¹H NMR (500 MHz, CDCl₃) δ 7.68-7.63 (m, 2H), 7.50-7.46 (m, 2H), 7.45-7.43 (m, 1H), 7.40-7.37 (m, 1H), 7.35 (t, J=7.0 Hz, 2H), 7.22 (ddd, J=16.9, 6.6, 2.6 Hz, 4H), 7.15 (dd, J=5.6, 3.2 Hz, 2H), 4.37-4.26 (m, 1H), 3.21 (dd, J=15.5, 7.3 Hz, 2H), 3.03 (dd, J=15.5, 7.6 Hz, 2H).

¹³C NMR (126 MHz, CDCl₃) δ 167.62, 142.46, 140.04, 137.48, 130.03, 128.63, 128.46, 128.20, 127.88, 126.42, 124.52, 63.48, 41.41.

¹⁵N NMR (51 MHz, CDCl₃) δ 334.29.

HRMS: ASAP (positive) M=C₂₂H₁₉N¹⁵: calculated (M+H)+m/z 300.1600; found (M+H)+m/z 300.1606.

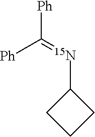 [SMILES: c1ccc(C(=[15N]C2CCC2)c2ccccc2)cc1]

(5g) N-cyclobutyl-1,1-diphenylmethanimine-¹⁵N: Synthesized according to General Procedure E from 14-cyclobutyl-7-phenyl-5,6,8,9-tetrahydrodibenzo[c,h]acridin-14-ium tetrafluoroborate (125 mg). Purified via preparatory TLC (3% EtOAc/pentane) to afford 41.5 mg (70%) of a yellow oil.

R_{f}: 0.72 (3% EtOAc/pentane, 1 drop Et₃N).

¹H NMR (400 MHz, CDCl₃) δ 7.66-7.58 (m, 2H), 7.44 (qd, J=4.7, 1.6 Hz, 3H), 7.34 (ddd, J=12.7, 7.8, 6.0 Hz, 3H), 7.19-7.08 (m, 2H), 4.08-3.95 (m, 1H), 2.30 (dddq, J=14.2, 9.8, 4.9, 2.4 Hz, 2H), 2.16-2.03 (m, 2H), 1.86 (tdd, J=12.2, 9.4, 2.9 Hz, 1H), 1.67 (qt, J=10.4, 8.3 Hz, 1H).

¹³C NMR (101 MHz, CDCl₃) δ 166.82 (d, J=5.6 Hz), 140.02 (d, J=7.7 Hz), 137.57 (d, J=2.5 Hz), 129.96, 128.60 (d, J=2.9 Hz), 128.48, 128.38, 128.14, 127.99, 57.27 (d, J=2.1 Hz), 31.54 (d, J=2.1 Hz), 16.16 (d, J=2.9 Hz).

¹⁵N NMR (51 MHz, CDCl₃) δ 320.10.

HRMS: ASAP (positive) M=C₁₇H₁₇N¹⁵: calculated (M+H)+m/z 238.1443; found (M+H)+m/z 238.1452.

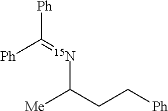 [SMILES: CC(CCc1ccccc1)[15N]=C(c1ccccc1)c1ccccc1]

(5h) N-(2-methyl-4-phenylbutyl)-1,1-diphenylmethanimine-¹⁵N: Synthesized according to General Procedure E from 2,4,6-triphenyl-1-(4-phenylbutan-2-yl)pyridin-1-ium tetrafluoroborate (131.8 mg). Purified via preparatory TLC (3% EtOAc/pentane) to afford 57.8 mg (70%) of a yellow oil.

R_{f}: 0.72 (3% EtOAc/pentane, 1 drop Et₃N).

¹H NMR (500 MHz, CDCl₃) δ 7.71-7.66 (m, 2H), 7.51-7.33 (m, 6H), 7.29 (t, J=7.4 Hz, 2H), 7.22-7.15 (m, 5H), 3.53 (dddd, J=8.3, 6.3, 4.4, 1.9 Hz, 1H), 2.66 (ddd, J=13.6, 11.0, 5.4 Hz, 1H), 2.50 (ddd, J=13.6, 10.9, 5.6 Hz, 1H), 2.08-1.95 (m, 1H), 1.92-1.81 (m, 1H), 1.26 (dd, J=6.3, 2.6 Hz, 3H).

¹³C NMR (126 MHz, CDCl₃) δ 166.59, 142.68, 140.34 (d, J=7.7 Hz), 137.52 (d, J=2.4 Hz), 129.84, 128.52, 128.50, 128.42, 128.35, 128.21, 128.16, 127.82, 125.68, 57.29, 40.17 (d, J=3.5 Hz), 33.23, 22.34 (d, J=2.3 Hz).

¹⁵N NMR (51 MHz, CDCl₃) δ 338.12.

HRMS: ASAP (positive) M=C₂₃H₂₃N¹⁵: calculated (M+H)+m/z 316.1913; found (M+H)+m/z 316.1851.

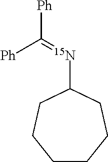 [SMILES: c1ccc(C(=[15N]C2CCCCCC2)c2ccccc2)cc1]

(5i) N-cycloheptyl-1,1-diphenylmethanimine-¹⁵N: Synthesized according to General Procedure E from 1-cycloheptyl-2,4,6-triphenylpyridin-1-ium tetrafluoroborate (122.7 mg). Light yellow oil (28.5 mg, 41%).

R_{f}: 0.76 (5% EtOAc/pentane, 1 drop Et₃N).

¹H NMR (500 MHz, CDCl₃) δ 7.60-7.55 (m, 2H), 7.43 (m, 3H), 7.37-7.28 (m, 3H), 7.17-7.11 (m, 2H), 3.39 (dtd, J=8.7, 4.3, 2.2 Hz, 1H), 1.73 (m, 4H), 1.68-1.45 (m, 6H), 1.41-1.29 (m, 2H).

¹³C NMR (126 MHz, CDCl₃) δ 164.36, 140.57, 137.64, 129.63, 128.51, 128.46, 128.17, 128.11, 127.85, 63.26, 35.98, 28.78, 24.69.

¹⁵N NMR (51 MHz, CDCl₃) δ 341.02.

IR (CDCl₃): 2923.06, 2854.68, 1608.46, 1444.32, 1313.79, 1108.21, 776.86, 695.76 cm⁻¹.

HRMS: ASAP (positive) M=C₂₀H₂₃N¹⁵: calculated (M+H)+m/z 281.1947; found (M+H)+m/z 281.1944.

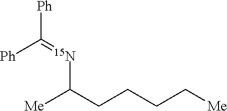 [SMILES: CCCCCC(C)[15N]=C(c1ccccc1)c1ccccc1]

(5j) N-(heptan-2-yl)-1,1-diphenylmethanimine-¹⁵N: Synthesized according to General Procedure E from 1-(heptan-2-yl)-2,4,6-triphenylpyridin-1-ium tetrafluoroborate (123.35 mg, 0.25 mmol). Light yellow oil (44.9 mg, 69%).

R_{f}: 0.8 (5% EtOAc/pentane, 1 drop Et₃N).

¹H NMR (500 MHz, CDCl₃) δ 7.60 (d, J=6.6 Hz, 2H), 7.51-7.38 (m, 3H), 7.37-7.28 (m, 3H), 7.18-7.12 (m, 2H), 3.38 (m, 1H), 1.62 (m, 1H), 1.46 (m, 1H), 1.38-1.06 (m, 10H), 0.85 (t, J=7.3 Hz, 3H).

¹³C NMR (126 MHz, CDCl₃) δ 165.97 (d, J=5.5 Hz), 140.54, 140.48, 137.79, 137.77, 129.71, 128.51, 128.48, 128.46, 128.15, 127.90, 57.60, 38.47, 32.02, 26.50, 22.78, 22.46, 14.21.

¹⁵N NMR (51 MHz, CDCl₃) δ 339.65.

IR (CDCl₃): 3059.43, 2959.02, 2925.72, 2856.96, 1608.20, 1573.23, 1284.70, 1137.19, 775.74, 695.04, 640.26 cm⁻¹.

HRMS: ASAP (positive) M=C₂₀H₂₅N¹⁵: calculated (M+H)+m/z 282.2069; found (M+H)+m/z 282.2075.

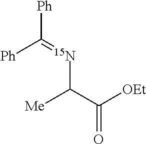 [SMILES: CCOC(=O)C(C)[15N]=C(c1ccccc1)c1ccccc1]

(5k) ethyl 2-((diphenylmethylene)amino-¹⁵N)propanoate: Synthesized according to General Procedure E from 1-(1-ethoxy-1-oxopropan-2-yl)-2,4,6-triphenylpyridin-1-ium tetrafluoroborate (123.75 mg). Isolated via column chromatography (2% EtOAc/pentane until all triphenyl pyridine elutes→5% EtOAc/pentane). Light yellow oil (44.2 mg, 64%).

R_{f}: 0.34 (5% EtOAc/pentane, 1 drop Et₃N).

¹H NMR (500 MHz, CDCl₃) δ 7.64 (d, J=7.6 Hz, 2H), 7.50-7.41 (m, 3H), 7.39 (t, J=7.6 Hz, 1H), 7.33 (t, J=7.6 Hz, 2H), 7.23-7.15 (m, 2H), 4.17 (m, 3H), 1.43 (dd, J=6.8, 2.7 Hz, 3H), 1.26 (t, J=7.1 Hz, 3H).

¹³C NMR (126 MHz, CDCl₃) δ 173.04 (d, J=2.3 Hz), 169.76 (d, J=5.4 Hz), 139.70 (d, J=8.2 Hz), 136.47 (d, J=2.3 Hz), 130.40, 128.92, 128.89, 128.75, 128.70, 128.17, 127.84, 60.97, 60.79, 19.30 (d, J=2.7 Hz), 14.33.z

¹⁵N NMR (51 MHz, CDCl₃) δ 321.17.

IR (CDCl₃): 3059.51, 2933.89, 1734.22, 1608.92, 1444.96, 1285.21, 1191.77, 1115.24, 779.93, 695.76 cm⁻¹.

HRMS: ASAP (positive) M=C₁₈H₁₉O₂N¹⁵: calculated (M+H)+m/z 284.1498; found (M+H)+m/z 284.1507.

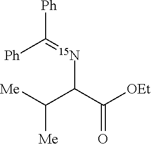 [SMILES: CCOC(=O)C([15N]=C(c1ccccc1)c1ccccc1)C(C)C]

(5l) ethyl 2-((diphenylmethylene)amino-¹⁵N)-3-methylbutanoate: Synthesized according to General Procedure E from 1-(1-ethoxy-4-methyl-1-oxopentan-2-yl)-2,4,6-triphenylpyridin-1-ium tetrafluoroborate (134.2 mg). Isolated via column chromatography (2% EtOAc/pentane until all triphenyl pyridine elutes→5% EtOAc/pentane). Light yellow oil (53.2 mg, 68%).

R_{f}: 0.3 (5% EtOAc/pentane, 1 drop Et₃N)

¹H NMR (500 MHz, CDCl₃) δ 7.65 (d, J=7.2 Hz, 2H), 7.45 (dd, J=5.2, 2.0 Hz, 3H), 7.42-7.37 (m, 1H), 7.33 (dd, J=8.2, 6.6 Hz, 2H), 7.23-7.16 (m, 2H), 4.25-4.13 (m, 2H), 4.10 (dd, J=9.0, 4.9 Hz, 1H), 1.88 (br s, 1H), 1.78 (ddt, J=13.3, 8.7, 4.5 Hz, 1H), 1.63-1.51 (sep, 1H), 1.27 (t, J=7.1 Hz, 3H), 0.85 (d, J=6.6 Hz, 3H), 0.67 (d, J=6.6 Hz, 3H).

¹³C NMR (126 MHz, CDCl₃) δ 172.88, 157.64, 139.72, 132.55, 130.19, 129.05, 128.84, 128.58, 128.41, 128.18, 128.07, 64.05, 60.98, 42.86, 24.84, 23.32, 21.81, 14.36.

¹⁵N NMR (51 MHz, CDCl₃) δ 320.03.

HRMS: ASAP (positive) M=C₂₁H₂₅N¹⁵O₂: calculated (M+H)+m/z 326.1968; found (M+H)+m/z 326.1972.

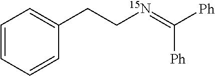 [SMILES: c1ccc(CC[15N]=C(c2ccccc2)c2ccccc2)cc1]

(6a) N-phenethyl-1,1-diphenylmethanimine-¹⁵N: Synthesized according to General Procedure E from 14-phenethyl-7-phenyl-5,6,8,9-tetrahydrodibenzo[c,h]acridin-14-ium tetrafluoroborate (137.8 mg, 0.25 mmol). Purified via flash chromatography (1% EtOAc/pentane→2% EtOAc/pentane, let all triphenylpyridine elute, followed by product) to yield 49.3 mg (69%) of a clear oil.

R_{f}: 0.37 (3% EtOAc/pentane, 1 drop Et₃N).

¹H NMR (400 MHz, CDCl₃) δ 7.62-7.55 (m, 2H), 7.41-7.29 (m, 6H), 7.24-7.21 (m, 2H), 7.19-7.09 (m, 3H), 7.00-6.91 (m, 2H), 3.64 (t, J=7.4 Hz, 2H), 3.01 (td, J=7.4, 2.3 Hz, 2H).

¹³C NMR (101 MHz, CDCl₃) δ 168.61 (d, J=6.1 Hz), 140.54 (d, J=1.9 Hz), 140.08, 140.00, 136.96 (d, J=2.5 Hz), 130.00, 129.18, 128.50, 128.49, 128.45, 128.36, 128.18, 127.84, 126.06, 55.71, 37.84 (d, J=3.2 Hz).

¹⁵N NMR (51 MHz, CDCl₃) δ 323.60.

HRMS: ASAP (positive) M=C₂₁H₁₉N¹⁵: calculated (M+H)+m/z 288.1600; found (M+H)+m/z 288.1598.

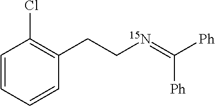 [SMILES: Clc1ccccc1CC[15N]=C(c1ccccc1)c1ccccc1]

(6b) N-(2-chlorophenethyl)-1,1-diphenylmethanimine-¹⁵N: Synthesized according to General Procedure E from 14-(2-chlorophenethyl)-7-phenyl-5,6,8,9-tetrahydrodibenzo[c,h]acridin-14-ium tetrafluoroborate (116.8 mg, 0.20 mmol). Purified via preparatory TLC (3% EtOAc/pentane) to afford 45.0 mg (70%) of a yellow oil.

¹H NMR (300 MHz, CDCl₃) δ 7.65 (d, J=7.5 Hz, 2H), 7.54-7.35 (m, 7H), 7.12 (td, J=6.7, 3.7 Hz, 3H), 6.95 (dd, J=6.4, 2.9 Hz, 2H), 3.75 (t, 2H), 3.19 (t, 2H).

¹³C NMR (101 MHz, CDCl₃) δ 169.01, 137.90 (d, J=23.1 Hz), 134.43, 132.55, 131.51, 130.21, 130.08, 129.49, 128.54, 128.42, 128.19, 127.83, 127.61, 126.68, 53.47, 35.38 (d, J=3.3 Hz).

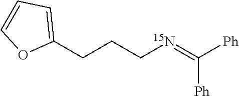 [SMILES: c1ccc(C(=[15N]CCCc2ccco2)c2ccccc2)cc1]

(6c) N-(3-(furan-3-yl)propyl)-1,1-diphenylmethanimine-¹⁵N: Synthesized according to General Procedure E from 14-(3-(furan-2-yl)propyl)-7-phenyl-5,6,8,9-tetrahydrodibenzo[c,h]acridin-14-ium tetrafluoroborate (111 mg, 0.2 mmol). Purified via silica gel chromatography with a gradient of 9:1 pentane:toluene→9:0.9:0.1 pentane:toluene:Et₂O→9:0.7:0.3 pentane:toluene:Et₂O to afford 47.4 mg (⁸²%).

R_{f}: 0.4 (90:0.5:0.5 pentane:toluene:Et₂O, 1 drop Et₃N).

¹H NMR (500 MHz, CDCl₃) δ 7.61 (d, J=7.6 Hz, 2H), 7.43 (m, 7H), 7.15 (d, J=7.1 Hz, 2H), 6.24 (t, J=2.4 Hz, 1H), 5.94 (d, J=2.4 Hz, 1H), 3.42 (t, J=6.8 Hz, 2H), 2.71 (t, J=7.0 Hz, 2H), 2.03 (pd, J=7.2, 2.5 Hz, 2H).

¹³C NMR (126 MHz, CDCl₃) δ 168.39 (d, J=6.0 Hz), 156.24, 140.82, 140.07 (d, J=8.1 Hz), 137.10, 129.99, 128.59, 128.46 (d, J=3.1 Hz), 128.42, 128.18, 127.94, 110.17, 104.85, 53.13, 29.63 (d, J=3.4 Hz), 26.00.

¹⁵N NMR (51 MHz, CDCl₃) δ 324.66.

IR (CDCl₃): 3058.81, 2926.14, 1594.54, 1444.80, 1288.34, 1006.02, 779.50, 696.69 cm⁻¹.

HRMS: ASAP (positive) M=C₂₀H₁₈ON¹⁵: calculated (M+H)+m/z 292.1549; found (M+H)+m/z 292.1544.

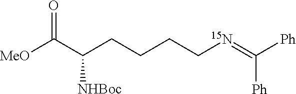 [SMILES: COC(=O)[C@H](CCCC[15N]=C(c1ccccc1)c1ccccc1)NC(=O)OC(C)(C)C]

(6d) Boc-¹⁵N-Lys-OMe: Synthesized according to General Procedure E from (S)-14-(5-((tert-butoxycarbonyl)amino)-6-methoxy-6-oxohexyl)-7-phenyl-5,6,8,9-tetrahydrodibenzo[c,h]acridin-14-ium tetrafluoroborate (69.0 mg, 0.1 mmol). Purified by column chromatography (5→10→15→20→100 EtOAc/pentane, comes out right after leftover benzophenone imine) to yield 22.4 mg (53%) of a light yellow oil.

R_{f}: 0.2 (20% EtOAc/pentane, 1 drop Et₃N).

¹H NMR (500 MHz, CDCl₃) δ 7.61-7.55 (m, 2H), 7.44 (ddd, J=12.1, 7.8, 6.1 Hz, 3H), 7.38-7.29 (m, 3H), 7.17-7.12 (m, 2H), 4.98 (d, J=8.7 Hz, 1H), 4.27 (d, J=6.7 Hz, 1H), 3.70 (s, 3H), 3.38-3.32 (m, 2H), 1.77 (d, J=9.8 Hz, 1H), 1.73-1.57 (m, 4H), 1.42 (s, 9H), 1.39 (m, 1H).

¹³C NMR (101 MHz, CDCl₃) δ 173.59, 168.18 (d, J=6.1 Hz), 155.50, 140.07 (d, J=8.1 Hz), 137.13 (d, J=2.5 Hz), 129.96, 128.62, 128.45, 128.44, 128.18, 127.93, 79.94, 53.57 (d, J=6.5 Hz), 52.30, 32.76, 30.90 (d, J=3.2 Hz), 28.46, 23.45 (d, J=1.9 Hz).

¹⁵N NMR (51 MHz, CDCl₃) δ 325.12.

HRMS: ASAP (positive) M=C₂₅H₃₃N¹⁵NO₄: calculated (M+H)+m/z 427.2444; found (M+H)+m/z 427.2449.

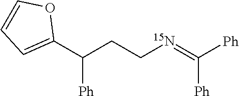 [SMILES: c1ccc(C(=[15N]CCC(c2ccccc2)c2ccco2)c2ccccc2)cc1]

(6e) N-(3-(furan-2-yl)-3-phenylpropyl)-1,1-diphenylmethanimine-¹⁵N: Synthesized according to General Procedure E from 14-(3-(furan-2-yl)-3-phenylpropyl)-7-phenyl-5,6,8,9-tetrahydrodibenzo[c,h]acridin-14-ium tetrafluoroborate (157.8 mg, 0.25 mmol). Purified by flash chromatography to yield 65.3 mg (65%) of a yellow oil.

R_{f}: 0.36 (85% hexanes, 12% toluene, 3% EtOAc)

¹H NMR (400 MHz, CDCl₃) δ 7.68-7.61 (m, 2H), 7.45-7.31 (m, 6H), 7.30-7.25 (m, 3H), 7.24-7.18 (m, 3H), 7.09-7.04 (m, 2H), 6.27 (dd, J=3.2, 1.8 Hz, 1H), 6.04 (d, J=3.2 Hz, 1H), 4.22 (t, J=7.7 Hz, 1H), 3.42-3.26 (m, 2H), 2.49 (dqd, J=14.3, 7.2, 2.3 Hz, 1H), 2.28 (dddd, J=15.7, 13.4, 6.7, 2.7 Hz, 1H).

¹³C NMR (101 MHz, CDCl₃) δ 168.42 (d, J=6.0 Hz), 157.96, 142.63, 141.38, 140.08, 140.00, 136.97, 132.54, 130.20, 129.99, 128.54, 128.48, 128.47, 128.44, 128.32, 128.17, 128.07, 127.80, 126.59, 110.05, 105.46, 51.48, 42.89 (d, J=1.8 Hz), 36.14 (d, J=3.5 Hz).

¹⁵N NMR (51 MHz, CDCl₃) δ 324.13.

HRMS: ASAP (positive) M=C₂₆H₂₃N¹⁵O: calculated (M+H)+m/z 368.1862; found (M+H)+m/z 368.1858.

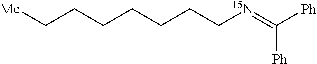 [SMILES: CCCCCCCC[15N]=C(c1ccccc1)c1ccccc1]

(6f) N-octyl-1,1-diphenylmethanimine-¹⁵N: Synthesized according to General Procedure E from 14-octyl-7-phenyl-5,6,8,9-tetrahydrodibenzo[c,h]acridin-14-ium tetrafluoroborate (139.5 mg, 0.25 mmol). Purified via preparatory TLC (5% EtOAc/pentane) to afford 57.4 mg (78%) of a yellow oil.

R_{f}: 0.8 (5% EtOAc/pentane, 1 drop Et₃N).

¹H NMR (500 MHz, CDCl₃) δ 7.65-7.59 (m, 2H), 7.49-7.30 (m, 6H), 7.20-7.14 (m, 2H), 3.38 (t, J=7.1 Hz, 2H), 1.69 (pd, J=7.1, 2.3 Hz, 2H), 1.48-1.22 (m, 12H), 0.88 (t, J=6.9 Hz, 3H).

¹³C NMR (126 MHz, CDCl₃) δ 167.77 (d, J=6.1 Hz), 140.23 (d, J=7.9 Hz), 137.25 (d, J=2.6 Hz), 129.83, 128.52, 128.42 (d, J=3.0 Hz), 128.32, 128.14, 127.99, 54.07, 31.99, 31.38 (d, J=3.1 Hz), 29.56, 29.39, 27.64, 22.79, 14.24.

¹⁵N NMR (51 MHz, CDCl₃) δ 326.81.

IR (CDCl₃): 2924.03, 2853.19, 1608.52, 1444.63, 1286.78, 1249.55, 1155.22, 694.81 cm⁻¹.

HRMS: ASAP (positive) M=C₂₁H₂₇N¹⁵: calculated (M+H)+m/z 296.2226; found (M+H)+m/z 296.2209.

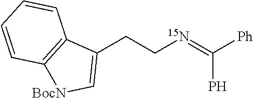

(6g) tert-butyl 3-(2-((diphenylmethylene)amino-¹⁵N)ethyl)-1H-indole-1-carboxylate: Synthesized according to General Procedure E from 14-(2-(1-(tert-butoxycarbonyl)-1H-indol-3-yl)ethyl)-7-phenyl-5,6,8,9-tetrahydrodibenzo[c,h]acridin-14-ium tetrafluoroborate (172.2 mg, 0.25 mmol). Purified by flash chromatography (2% EtOAc/hexanes until triphenylpyridine elutes, then ramp to 5->10% EtOAc/hexanes) to yield 55.4 mg (52%) of a yellow oil.

R_{f}: 0.47 (10% EtOAc/hexanes).

¹H NMR (500 MHz, CDCl₃) δ 8.11, (br s, 1H), 7.63 (d, J=7.0 Hz, 2H), 7.42-7.37 (m, 6H), 7.34 (dd, J=8.2, 6.5 Hz, 2H), 7.29 (ddd, J=8.4, 7.1, 1.2 Hz, 1H), 7.19-7.15 (m, 1H), 7.06 (dd, J=6.5, 2.9 Hz, 2H), 3.77-3.70 (m, 2H), 3.09 (tdd, J=7.1, 2.3, 1.1 Hz, 2H), 1.65 (s, 9H).

¹³C NMR (126 MHz, CDCl₃) δ 168.77 (d, J=6.0 Hz), 149.93, 139.97 (d, J=8.1 Hz), 136.85 (d, J=2.6 Hz), 135.52, 132.53, 130.94, 130.19, 130.04, 128.57, 128.50, 128.48, 128.42, 128.17, 127.81, 124.25, 123.16, 122.34, 119.32-119.11 (m), 115.25, 83.36, 53.76, 28.34, 26.90 (d, J=3.6 Hz).

¹⁵N NMR (51 MHz, CDCl₃) δ 323.86.

HRMS: ASAP (positive) M=C₂₈H₂₈N¹⁵NO₂: calculated (M+H)+m/z 427.2232; found (M+H)+m/z 427.2233.

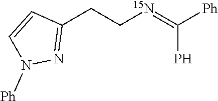

(6h) 1,1-diphenyl-N-(2-(1-phenyl-1H-pyrazol-3-yl)ethyl)methanimine-¹⁵N: Synthesized according to General Procedure E from 7-phenyl-14-(2-(1-phenyl-1H-pyrazol-4-yl)ethyl)-5,6,8,9-tetrahydrodibenzo[c,h]acridin-14-ium tetrafluoroborate (154.3 mg, 0.25 mmol). Purified by flash chromatography to yield 70.3 mg (80%) of a clear oil.

¹H NMR (500 MHz, CDCl₃) δ 7.70 (s, 1H), 7.62 (ddd, J=6.7, 5.0, 2.4 Hz, 4H), 7.54 (s, 1H), 7.43-7.37 (m, 6H), 7.36-7.31 (m, 2H), 7.26-7.21 (m, 1H), 7.09-7.00 (m, 2H), 3.63 (td, J=6.9, 1.1 Hz, 2H), 2.94 (td, J=6.9, 2.7 Hz, 2H).

¹³C NMR (101 MHz, CDCl₃) δ 168.74 (d, J=6.1 Hz), 141.56, 140.40, 139.94, 139.86, 136.93 (d, J=2.5 Hz), 132.51, 130.17, 130.08, 129.45, 128.56, 128.46, 128.44, 128.39, 128.21, 127.82, 126.11, 125.48, 121.87 (d, J=1.7 Hz), 118.88, 54.82 (d, J=1.4 Hz), 26.25 (d, J=3.5 Hz).

¹⁵N NMR (51 MHz, CDCl₃) δ 323.54.

LRMS: (EI) [C₂₄H₂₁N₂N15]: m/z calculated 352.17; found 352.1.

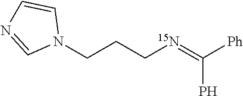

(6i) N-(3-(1H-imidazol-1-yl)propyl)-1,1-diphenylmethanimine-¹⁵N: Synthesized according to General Procedure #from 14-(3-(1H-imidazol-1-yl)propyl)-7-phenyl-5,6,8,9-tetrahydrodibenzo[c,h]acridin-14-ium tetrafluoroborate (139 mg, 0.25 mmol). Purified by preparatory TLC (50% EtOAc/hexanes) to yield 59.4 mg (82%) of a clear oil.

R_{f}: 0.09 (50% EtOAc/hexanes)

¹H NMR (500 MHz, CDCl₃) δ 7.65-7.59 (m, 2H), 7.52-7.39 (m, 5H), 7.34 (dd, J=8.2, 6.5 Hz, 2H), 7.14-7.08 (m, 2H), 7.03 (s, 1H), 6.90 (s, 1H), 4.17-4.08 (m, 2H), 3.32 (td, J=6.4, 1.4 Hz, 2H), 2.12 (pd, J=6.8, 2.9 Hz, 2H).

¹³C NMR (126 MHz, CDCl₃) δ 169.19 (d, J=6.0 Hz), 139.69, 139.62, 137.38, 136.74, 130.29, 129.54, 128.77, 128.68, 128.44, 128.41, 128.27, 127.66, 119.01, 49.98, 44.93, 32.54 (d, J=3.9 Hz).

¹⁵N NMR (51 MHz, CDCl₃) δ 320.60.

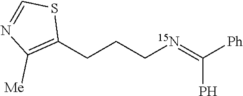

(6j) N-(3-(4-methylthiazol-5-yl)propyl)-1,1-diphenylmethanimine-¹⁵N: Synthesized according to General Procedure E from 14-(3-(4-methylthiazol-5-yl)propyl)-7-phenyl-5,6,8,9-tetrahydrodibenzo[c,h]acridin-14-ium tetrafluoroborate (146.25 mg, 0.25 mmol). Purified by flash chromatography (2% EtOAc/hexanes until triphenylpyridine elutes, then ramp to 5% EtOAc/hexanes) to yield 54.5 mg (68%) of a yellow oil.

R_{f}: 0.44 (5% EtOAc/hexanes, 1 drop Et₃N).

¹H NMR (500 MHz, CDCl₃) δ 7.61 (d, J=7.6 Hz, 2H), 7.42 (dd, J=9.2, 6.9 Hz, 3H), 7.38 (t, J=7.3 Hz, 1H), 7.32 (t, J=7.4 Hz, 2H), 7.17-7.12 (m, 2H), 6.69 (d, J=1.4 Hz, 1H), 3.47 (t, J=6.8 Hz, 2H), 3.07 (t, J=7.8 Hz, 2H), 2.39 (s, 3H), 2.16 (t, J=7.2 Hz, 2H).

¹³C NMR (101 MHz, CDCl₃) δ 170.71, 152.24, 136.99, 132.55, 130.21, 130.10, 128.63, 128.54, 128.51, 128.42, 128.19, 127.90, 112.44, 52.91, 31.62 (d, J=3.5 Hz), 31.56 (d, J=1.9 Hz), 17.18.

¹⁵N NMR (51 MHz, CDCl₃) δ 323.81.

HRMS: ASAP (positive) M=C₂₀H₂₀N¹⁵NS: calculated (M+H)+m/z 323.1427; found (M+H)+m/z 323.1428.

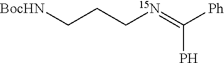

(6k) tert-butyl (3-((diphenylmethylene)amino-¹⁵N)propyl)carbamate: Synthesized according to General Procedure E from 14-(3-((tert-butoxycarbonyl)amino)propyl)-7-phenyl-5,6,8,9-tetrahydrodibenzo[c,h]acridin-14-ium tetrafluoroborate (151 mg, 0.25 mmol). Purified by flash chromatography to yield 56.7 mg (67%) of a white solid.

R_{f}: 0.54 (30% EtOAc/hexanes)

¹H NMR (500 MHz, CDCl₃) δ 7.62-7.57 (m, 2H), 7.45 (dt, J=12.2, 6.7 Hz, 3H), 7.38 (t, J=7.2 Hz, 1H), 7.32 (t, J=7.5 Hz, 2H), 7.18-7.12 (m, 2H), 5.41 (s, 1H), 3.43 (t, J=6.4 Hz, 2H), 3.28 (d, J=6.5 Hz, 2H), 1.88-1.78 (m, 2H), 1.44 (s, 9H).

¹³C NMR (126 MHz, CDCl₃) δ 168.59, 156.16, 139.75 (d, J=8.0 Hz), 136.80, 130.15, 128.72, 128.58, 128.46, 128.44, 128.23, 127.81, 78.86, 52.50, 40.08, 30.93, 28.60.

¹⁵N NMR (51 MHz, CDCl₃) δ 321.87.

HRMS: ASAP (positive) M=C₂₁H₂₆N¹⁵NO₂: calculated (M+H)+m/z 341.2076; found (M+H)+m/z 341.2081.

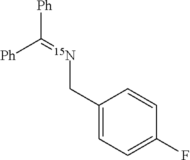 [SMILES: Fc1ccc(C[15N]=C(c2ccccc2)c2ccccc2)cc1]

(6l) N-(4-fluorobenzyl)-1,1-diphenylmethanimine-¹⁵N: Synthesized according to General Procedure E from 14-(4-fluorobenzyl)-7-phenyl-5,6,8,9-tetrahydrodibenzo[c,h]acridin-14-ium tetrafluoroborate (111 mg, 0.2 mmol). Isolated via preparatory TLC (90% pentane, 9% toluene, 1% EtOAc) to yield 37.1 mg (64%) of a white solid.

R_{f}: 0.21 (90% pentane, 9% toluene, 1% EtOAc)

¹H NMR (500 MHz, CDCl₃) δ 7.70-7.65 (m, 2H), 7.52-7.45 (m, 3H), 7.42-7.38 (m, 1H), 7.34 (dd, J=8.2, 6.6 Hz, 2H), 7.29 (dd, J=8.4, 5.6 Hz, 2H), 7.22-7.16 (m, 2H), 7.05-6.97 (m, 2H), 4.56 (s, 2H).

¹³C NMR (126 MHz, CDCl₃) δ 169.11 (d, J=5.6 Hz), 162.83, 160.89, 139.79 (d, J=8.4 Hz), 136.79 (d, J=2.6 Hz), 136.50, 130.30, 129.26, 129.20, 128.77, 128.74, 128.69, 128.67, 128.24, 127.87, 115.22 (d, J=21.3 Hz), 56.78.

¹⁵N NMR (51 MHz, CDCl₃) δ 320.41.

¹⁹F NMR (471 MHz, CDCl₃) δ −115.91.

HRMS: ASAP (positive) M=C₂₀H₁₆N¹⁵F: calculated (M+H)+m/z 292.1349; found (M+H)+m/z 292.1342.

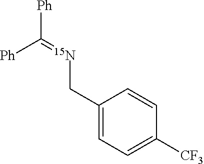 [SMILES: FC(F)(F)c1ccc(C[15N]=C(c2ccccc2)c2ccccc2)cc1]

(6m) N-(4-trifluoromethylbenzyl)-1,1-diphenylmethanimine-¹⁵N: Synthesized according to General Procedure E from 14-(4-trifluoromethylbenzyl)-7-phenyl-5,6,8,9-tetrahydrodibenzo[c,h] acridin-14-ium tetrafluoroborate (121 mg, 0.2 mmol). Isolated via preparatory TLC (90% pentane, 9% toluene, 1% EtOAc) to yield 23.0 mg (34%) of a clear oil.

R_{f}: 0.20 (90% pentane, 9% toluene, 1% EtOAc)

¹H NMR (500 MHz, CDCl₃) δ 7.67-7.61 (m, 2H), 7.46-7.40 (m, 2H), 7.33 (dd, J=7.8, 1.6 Hz, 4H), 7.07 (d, J=8.0 Hz, 2H), 7.01-6.95 (m, 2H), 4.92 (s, 2H).

¹³C NMR (101 MHz, CDCl₃) δ 145.64, 136.83, 130.99, 130.28, 128.88, 128.63, 128.40, 128.20 (d, J=7.6 Hz), 124.86, 73.55.

¹⁵N NMR (51 MHz, CDCl₃) δ 326.96.

LRMS: (EI) [C₂₁H₁₆F₃N15]: m/z calculated 340.12; found 340.2.

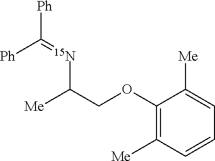 [SMILES: Cc1cccc(C)c1OCC(C)[15N]=C(c1ccccc1)c1ccccc1]

(7a) ¹⁵N-Mexilitene: Synthesized according to General Procedure E from 1-(1-(2,6-dimethylphenoxy)propan-2-yl)-2,4,6-triphenylpyridin-1-ium tetrafluoroborate (55.7 mg, 0.1 mmol). Isolated via preparatory TLC (5% EtOAc/hexanes). Light yellow oil (26.6 mg, 77%).

R_{f}: 0.45 (5% EtOAc/hexanes).

¹H NMR (500 MHz, CDCl₃) δ 7.74 (ddt, J=8.4, 6.9, 1.2 Hz, 3H), 7.45-7.37 (m, 3H), 7.33-7.27 (m, 1H), 7.22-7.14 (m, 3H), 6.94 (d, J=7.4 Hz, 2H), 6.87 (dd, J=8.2, 6.6 Hz, 1H), 4.17-4.06 (m, 1H), 3.87-3.72 (m, 2H), 2.17 (s, 6H), 1.29 (d, J=6.4 Hz, 3H).

¹³C NMR (126 MHz, CDCl₃) δ 159.43, 155.98 (d, J=11.0 Hz), 154.42, 142.70, 138.43, 132.02, 131.10, 130.44, 129.42, 128.96, 128.78, 128.68, 128.41, 128.15, 127.54 (d, J=6.0 Hz), 127.29, 124.20, 123.67, 105.77, 76.67, 59.77, 18.54, 16.38.

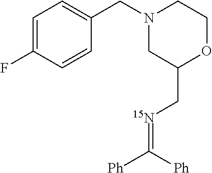 [SMILES: Fc1ccc(CN2CCOC(C[15N]=C(c3ccccc3)c3ccccc3)C2)cc1]

(7b) ¹⁵N-Mosapride intermediate: Synthesized according to General Procedure E from 14-((4-(4-fluorobenzyl)morpholin-2-yl)methyl)-7-phenyl-5,6,8,9-tetrahydrodibenzo[c,h]acridin-14-ium tetrafluoroborate (130.8 mg, 0.2 mmol). Isolated via preparatory TLC (25% EtOAc/hexanes) to yield mg (%) of a clear oil.

R_{f}: 0.18 (25% EtOAc/hexanes)

¹H NMR (500 MHz, CDCl₃) δ 7.61-7.54 (m, 2H), 7.47-7.40 (m, 3H), 7.39-7.35 (m, 1H), 7.34-7.26 (m, 4H), 7.17-7.11 (m, 2H), 7.06-6.96 (m, 2H), 3.93-3.86 (m, 1H), 3.84 (ddd, J=11.3, 3.3, 1.7 Hz, 1H), 3.69 (td, J=11.3, 2.4 Hz, 1H), 3.56-3.47 (m, 1H), 3.44 (d, J=13.0 Hz, 1H), 3.33 (ddd, J=14.2, 6.9, 1.5 Hz, 1H), 2.95 (dt, J=11.2, 2.1 Hz, 1H), 2.62 (dq, J=11.4, 2.0 Hz, 1H), 2.14 (td, J=11.3, 3.3 Hz, 1H), 1.95 (dd, J=11.3, 9.9 Hz, 1H).

¹³C NMR (126 MHz, CDCl₃) δ 169.50 (d, J=6.3 Hz), 163.15, 161.21, 139.86 (d, J=8.3 Hz), 136.82 (d, J=2.6 Hz), 133.74 (d, J=3.3 Hz), 130.76 (d, J=7.9 Hz), 130.13, 128.67, 128.57, 128.13, 127.93, 115.24, 115.07, 76.32 (d, J=4.8 Hz), 66.98, 62.63, 57.34, 56.89, 53.05.

¹⁵N NMR (51 MHz, CDCl₃) δ 316.14.

¹⁹F NMR (470 MHz, CDCl₃) δ −115.88 (m).

HRMS: ASAP (positive) M=C₂₅H₂₅N¹⁵NOF: calculated (M+H)+m/z 390.2000; found (M+H)+m/z 390.1993.

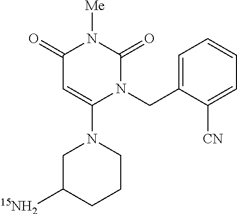 [SMILES: Cn1c(=O)cc(N2CCCC([15NH2])C2)n(Cc2ccccc2C#N)c1=O]

(7d) ¹⁵N-Agoliptin: ¹⁵N-labeled benzophenone imine protected Agoliptin was synthesized according to General Procedure E from the corresponding Katritzky pyridinium salt (143.4 mg, 0.2 mmol). The imine was isolated via preparatory TLC (30% EtOAc/hexanes) to yield a clear oil. This imine was dissolved in 1:1 THF: HCl (1M), total concentration 0.05 M and stirred for four hours, checking that starting material was consumed via TLC. The solution was extracted with EtOAc three times, then basified with NaOH to pH ˜10. This aqueous solution was again extracted with EtOAc (3×) and dried with Na₂SO₄, then concentrated in vacuo to yield a clear oil (35.3 mg, 52%).

¹H NMR (500 MHz, CDCl₃) δ 7.67 (dt, J=7.8, 0.9 Hz, 1H), 7.56 (td, J=7.7, 1.4 Hz, 1H), 7.38 (td, J=7.7, 1.2 Hz, 1H), 7.15-7.11 (m, 1H), 5.37 (s, 1H), 5.34-5.24 (m, 2H), 3.31 (s, 3H), 3.02 (dd, J=11.6, 3.8 Hz, 1H), 2.97-2.86 (m, 2H), 2.60 (t, J=11.0 Hz, 1H), 2.39 (d, J=8.4 Hz, 1H), 1.98-1.89 (m, 1H), 1.76 (tdd, J=8.0, 6.0, 3.9 Hz, 1H), 1.66-1.54 (m, 1H), 1.21 (d, J=10.9 Hz, 1H).

¹³C NMR (126 MHz, CDCl₃) δ 163.23, 159.88, 152.87, 140.97, 133.39, 133.25, 128.05, 126.76, 117.21, 110.92, 90.68, 59.70, 52.02, 47.47, 46.44, 33.53, 29.83, 28.12, 23.33.

¹⁵N NMR (51 MHz, CDCl₃) δ 33.95.

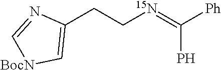

(7e) ¹⁵N-Boc-Histamine: Synthesized according to General Procedure E from 14-(2-(1-(tert-butoxycarbonyl)-1H-imidazol-4-yl)ethyl)-7-phenyl-5,6,8,9-tetrahydrodibenzo[c,h]acridin-14-ium tetrafluoroborate (64.1 mg, 0.1 mmol). Isolated via preparatory TLC (20% EtOAc/hexanes) to yield 30.1 mg (80%) of a clear oil.

R_{f}: 0.2 (20% EtOAc/hexanes).

¹H NMR (500 MHz, CDCl₃) δ 7.95 (d, J=1.3 Hz, 1H), 7.61-7.57 (m, 2H), 7.46-7.35 (m, 5H), 7.33-7.30 (m, 2H), 7.14-7.09 (m, 3H), 3.66 (td, J=7.2, 1.2 Hz, 2H), 2.96 (tdd, J=7.2, 2.5, 1.0 Hz, 2H), 1.59 (s, 9H).

¹³C NMR (126 MHz, CDCl₃) δ 168.63 (d, J=6.0 Hz), 147.32, 142.42, 140.09 (d, J=8.2 Hz), 136.95, 136.52, 130.01, 128.63, 128.51, 128.17, 127.90, 113.59, 85.24, 53.14, 30.39 (d, J=4.0 Hz), 27.57.

¹⁵N NMR (51 MHz, CDCl₃) δ 323.97.

HRMS: ASAP (positive) M=C₁₇H₁₇N¹⁵: calculated (M+H)+m/z 238.1443; found (M+H)+m/z 238.1452.

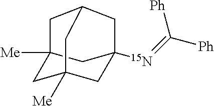 [SMILES: CC12CC3CC(C)(C1)CC([15N]=C(c1ccccc1)c1ccccc1)(C3)C2]

(7f) N-(3,5-dimethyladamantan-1-yl)-1,1-diphenylmethanimine-¹⁵N: Synthesized according to General Procedure C from N-(3,5-dimethyladamantan-1-yl)-1-(2,4,6-trimethoxyphenyl)methanimine (71.4 mg, 0.2 mmol). Isolated via preparatory TLC (3% EtOAc/hexanes). Clear oil (31.2 mg, 50%).

R_{f}: 0.60 (5% EtOAc/hexanes)

¹H NMR (500 MHz, CDCl₃) δ 7.54 (dt, J=6.9, 1.6 Hz, 2H), 7.41-7.32 (m, 3H), 7.31-7.26 (m, 3H), 7.21-7.15 (m, 2H), 2.01 (p, J=3.2 Hz, 1H), 1.51 (d, J=3.2 Hz, 2H), 1.38 (s, 4H), 1.19 (d, J=3.3 Hz, 4H), 1.10-0.99 (m, 2H), 0.75 (s, 3H).

¹³C NMR (126 MHz, CDCl₃) δ 163.13 (d, J=6.7 Hz), 142.31 (d, J=8.9 Hz), 140.47, 130.22, 129.39, 128.90, 128.47, 128.38, 128.18 (d, J=3.2 Hz), 127.98, 127.91, 127.77, 127.64, 127.40, 127.32, 126.55, 60.01, 50.74, 50.68, 42.86, 42.48, 32.50, 30.68, 30.57, 29.85.

¹⁵N NMR (51 MHz, CDCl₃) δ 354.16.

HRMS: ASAP (positive) M=C₂₅H₂₉N¹⁵: calculated (M+H)+m/z 346.2383; found (M+H)+m/z 346.2389.

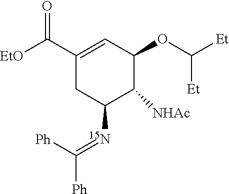 [SMILES: CCOC(=O)C1=C[C@@H](OC(CC)CC)[C@H](NC(C)=O)[C@@H]([15N]=C(c2ccccc2)c2ccccc2)C1]

(7g) ¹⁵N-Tamiflu: Synthesized according to General Procedure E from 1-((1S,5R,6R)-6-acetamido-3-(ethoxycarbonyl)-5-(pentan-3-yloxy)cyclohex-3-en-1-yl)-2,4,6-triphenylpyridin-1-ium tetrafluoroborate (69 mg, 0.1 mmol). Isolated via preparatory TLC (60% hexanes, 30% EtOAc, 10% toluene). Clear oil (33.9 mg, 71%). NMR shows rotameric protons that can be resolved through variable temperature NMR. Reported shifts are for one rotamer.

¹H NMR (500 MHz, CDCl₃) δ 7.62-7.58 (m, 2H), 7.49-7.43 (m, 3H), 7.34 (dd, J=8.1, 6.5 Hz, 2H), 7.14 (ddd, J=6.9, 3.7, 1.6 Hz, 3H), 6.76 (t, J=2.2 Hz, 1H), 5.46 (d, J=7.9 Hz, 1H), 4.45 (ddt, J=9.0, 3.6, 1.9 Hz, 1H), 4.26-4.16 (m, 3H), 4.01 (ddd, J=10.7, 9.8, 6.0 Hz, 1H), 3.88-3.77 (m, 1H), 3.32 (dp, J=17.2, 5.7 Hz, 1H), 2.62-2.52 (ddt, J=25, 10, 5 Hz 1H), 2.51-2.40 (m, 2H), 1.93 (s, 3H), 1.59-1.42 (m 4H), 1.29 (td, J=7.1, 5.6 Hz, 3H), 0.90 (dt, J=11.3, 7.4 Hz, 6H).

¹³C NMR (126 MHz, CDCl₃) δ 174.00, 169.79, 166.54, 140.08, 138.59, 137.33, 136.51, 130.21, 129.32, 129.03, 128.68, 128.57, 128.23, 127.96, 127.52, 81.94, 76.53, 73.41, 60.84, 58.93, 31.80, 26.49, 25.84, 23.94, 14.32, 9.72, 9.51.

¹⁵N NMR (51 MHz, CDCl₃) δ 322.92.

HRMS: ASAP (positive) M=C₂₉H₃₆N¹⁵NO₄: calculated (M+H)+m/z 478.2724; found (M+H)+m/z 478.2725.

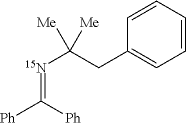 [SMILES: CC(C)(Cc1ccccc1)[15N]=C(c1ccccc1)c1ccccc1]

(7h) N-(2-methyl-1-phenylpropan-2-yl)-1,1-diphenylmethanimine-¹⁵N: Synthesized according to General Procedure C from N-(2-methyl-1-phenylpropan-2-yl)-1-(2,4,6-trimethoxyphenyl)methanimine (65.4 mg, 0.2 mmol). Isolated via preparatory TLC (3% EtOAc/hexanes). Clear oil (31.2 mg, 50%).

¹H NMR (500 MHz, CDCl₃) δ 7.58-7.55 (m, 2H), 7.31 (dddd, J=8.9, 8.2, 5.9, 3.9 Hz, 6H), 7.25-7.20 (m, 5H), 6.96-6.89 (m, 2H), 2.95 (d, J=2.9 Hz, 2H), 1.04 (d, J=1.8 Hz, 6H).

¹³C NMR (101 MHz, CDCl₃) δ 163.22 (d, J=6.8 Hz), 142.07 (d, J=9.0 Hz), 140.01 (d, J=2.6 Hz), 139.43, 132.55, 131.06, 130.21, 129.43, 128.48, 128.42, 128.40, 128.25, 128.22, 127.99, 127.79, 127.75, 127.40, 126.64, 126.06, 60.73 (d, J=1.9 Hz), 52.04 (d, J=4.0 Hz), 28.97.

¹⁵N NMR (51 MHz, CDCl₃) δ 351.15.

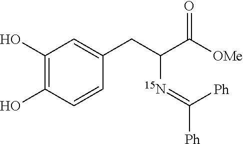 [SMILES: COC(=O)C(Cc1ccc(O)c(O)c1)[15N]=C(c1ccccc1)c1ccccc1]

(7i) ¹⁵N-DOPA: Synthesized according to General Procedure E from 1-(3-(3,4-dihydroxyphenyl)-1-methoxy-1-oxopropan-2-yl)-2,4,6-triphenylpyridin-1-ium tetrafluoroborate (50.0 mg, 0.08 mmol). Isolated via preparatory TLC (10% toluene, 90% EtOAc). Light yellow oil (17.2 mg, 53%).

R_{f}: 0.1 (10% toluene, 90% EtOAc).

¹H NMR (500 MHz, CDCl₃) δ 7.62-7.56 (m, 2H), 7.41-7.29 (m, 6H), 6.74 (d, J=7.1 Hz, 2H), 6.70 (d, J=8.0 Hz, 1H), 6.53 (d, J=2.0 Hz, 1H), 6.50-6.47 (m, 1H), 4.27 (dd, J=9.2, 4.4 Hz, 1H), 3.73 (d, J=2.2 Hz, 3H), 3.17 (dd, J=13.4, 4.5 Hz, 1H), 3.10-3.01 (m, 1H).

¹³C NMR (126 MHz, CDCl₃) δ 172.63, 171.25, 143.39, 142.48, 139.51, 136.19, 130.68, 130.49, 128.96, 128.62, 128.35, 128.18, 127.85, 122.41, 116.89, 115.21, 67.46, 52.38, 39.30.

¹⁵N NMR (51 MHz, CDCl₃) δ 314.44.

HRMS: ASAP (positive) M=C₂₃H₂₁N¹⁵O₄: calculated (M+H)+m/z 377.1519; found (M+H)+m/z 377.1510.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and/or rearranged in various ways within the scope and spirit of the invention to produce further embodiments that are also within the scope of the invention. Those skilled in the art will recognize, or be able to ascertain, using no more than routine experimentation, numerous equivalents to the specific embodiments described specifically in this disclosure. Such equivalents are intended to be encompassed in the scope of the following claims.

### REFERENCES

1. Ma, Y. et al. Enediolate-Dilithium Amide Mixed Aggregates in the Enantioselective Alkylation of Arylacetic Acids: Structural Studies and a Stereochemical Model. J. Am. Chem. Soc. 135, 16853-16864 (2013).
2. Yu, X., Chen, K., Yang, F., Zha, S. & Zhu, J. Oxadiazolone-Enabled Synthesis of Primary Azaaromatic Amines. Org. Lett. 18, 5412-5415 (2016).
3. Pintér, Á., Haberhauer, G., Hyla-Kryspin, I. & Grimme, S. Configurationally stable propeller-like triarylphosphine and triarylphosphine oxide. Chem. Commun. 3711-3713 (2007) doi:10.1039/B709655K.
4. Ashley, M. A. & Rovis, T. Photoredox-Catalyzed Deaminative Alkylation via C—N Bond Activation of Primary Amines. J. Am. Chem. Soc. (2020) doi:10.1021/jacs.0c08595.
5. Dorsheimer, J. R., Ashley, M. A. & Rovis, T. Dual Nickel/Photoredox-Catalyzed Deaminative Cross-Coupling of Sterically Hindered Primary Amines. J. Am. Chem. Soc. 143, 19294-19299(2021).
6. Ma, Y. et al. Radical C—N Borylation of Aromatic Amines Enabled by a Pyrylium Reagent. Chem.—Eur. J. 26, 3738-3743 (2020).
7. Basch, C. H., Liao, J., Xu, J., Piane, J. J. & Watson, M. P. Harnessing Alkyl Amines as Electrophiles for Nickel-Catalyzed Cross Couplings via C—N Bond Activation. J. Am. Chem. Soc. 139, 5313-5316 (2017).
8. Hoerrner, M. E., Baker, K. M., Basch, C. H., Bampo, E. M. & Watson, M. P. Deaminative Arylation of Amino Acid-derived Pyridinium Salts. Org. Lett. 21, 7356-7360 (2019).
9. Wu, J., He, L., Noble, A. & Aggarwal, V. K. Photoinduced Deaminative Borylation of Alkylamines. J. Am. Chem. Soc. 140, 10700-10704 (2018).
10. Martin-Montero, R., Yatham, V. R., Yin, H., Davies, J. & Martin, R. Ni-Catalyzed Reductive Deaminative Arylation at sp3 Carbon Centers. 163.
11. Hu, J., Cheng, B., Yang, X. & Loh, T.-P. Transition-Metal-Free Deaminative Vinylation of Alkylamines. Adv. Synth. Catal. 361, 4902-4908 (2019).
12. Schönbauer, D., Sambiagio, C., Noël, T. & Schnürch, M. Photocatalytic deaminative benzylation and alkylation of tetrahydroisoquinolines with N-alkylpyrydinium salts. Beilstein J. Org. Chem. 16, 809-817 (2020).
13. Andrews, J. A., Pantaine, L. R. E., Palmer, C. F., Poole, D. L. & Willis, M. C. Sulfinates from Amines: A Radical Approach to Alkyl Sulfonyl Derivatives via Donor—Acceptor Activation of Pyridinium Salts. Org. Lett. 23, 8488-8493 (2021).
14. Li, C.-L., Jiang, X., Lu, L.-Q., Xiao, W.-J. & Wu, X.-F. Cobalt(II)-Catalyzed Alkoxycarbonylation of Aliphatic Amines via C—N Bond Activation. Org. Lett. 21, 6919-6923 (2019).
15. Zeng, X. et al. Copper-Catalyzed Deaminative Difluoromethylation. Angew. Chem. Int. Ed. 59, 16398-16403 (2020).

What is claimed is:

1. A method for producing a ¹⁵N-labeled compound having an alpha-tertiary amine, the method comprising:
activating an alpha-tertiary amine via condensation with an electron-rich aldehyde to generate a redox-active imine;
catalyzing the redox-active imine with an excited state photocatalyst to generate an imidoyl radical;
modifying the imidoyl radical via beta-scission to generate a tertiary radical;
adding a sacrificial oxidant to the tertiary radical to generate a carbocation; and
trapping the carbocation with an ¹⁵N-labeled nucleophile to yield the ¹⁵N-labeled compound having the alpha-tertiary amine.

2. The method of claim 1, wherein the alpha-tertiary amine is a pharmaceutical compound, an agricultural compound or an environmental compound.

3. The method of claim 1, wherein the excited state photocatalyst comprises an oxidizing iridium photocatalyst.

4. The method of claim 1, wherein the sacrificial oxidant comprises potassium persulfate.

5. The method of claim 1, wherein the ¹⁵N-labeled compound having the alpha-tertiary amine is:

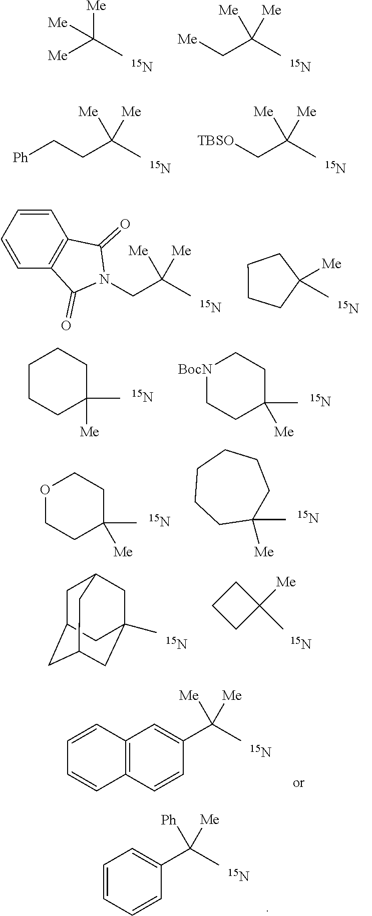

6. The method of claim 1, wherein the electron-rich aldehyde comprises 2,4,6-trimethoxybenzealdehyde.

7. The method of claim 1, wherein the ¹⁵N-labeled nucleophile comprises ¹⁵N-labeled benzophenone imine.

8. The method of claim 1, wherein the electron-rich aldehyde comprises 2,4,6-trimethoxybenzealdehyde and the ¹⁵N-labeled nucleophile comprises ¹⁵N-labeled benzophenone imine.

9. The method of claim 3, wherein the electron-rich aldehyde comprises 2,4,6-trimethoxybenzealdehyde and the ¹⁵N-labeled nucleophile comprises ¹⁵N-labeled benzophenone imine.

10. A method for producing a ¹⁵N-labeled compound having an alpha-primary amine or alpha-secondary amine comprising:
condensing an alpha-primary amine or alpha-secondary amine with a pyrilium salt to generate a Katritzky pyridinium salt;
mixing the Katritzky pyridinium salt and a copper(I) catalyst containing a 1,3-diketone ligand in the presence of a base to generate an electron-donor-acceptor complex, wherein the electron-donor-acceptor complex absorbs blue light;
fragmenting the electron-donor-acceptor complex to generate a primary or secondary radical and a Cu(II) species;
exchanging a ligand of the Cu(II) species with an ¹⁵N-labeled benzophenone imine and trapping the primary or secondary radical to generate a Cu(III) species; and
generating the ¹⁵N-labeled compound having the alpha-primary amine or alpha-secondary amine by reductive elimination of the Cu(III) species.

11. The method of claim 10, wherein the alpha-primary amine or alpha-secondary amine is a pharmaceutical compound, an agricultural compound or an environmental compound.

12. The method of claim 10, further comprising irradiating the electron-donor-acceptor complex with light having a wavelength of between about 400 nm and 500 nm.

13. The method of claim 12, wherein the light has a wavelength of about 456 nm.

14. The method of claim 10, wherein the 1,3-diketone ligand comprises a tetramethylheptanedianato (TMHD) ligand.

15. The method of claim 10, wherein the base is cesium carbonate.

16. The method of claim 10, wherein the ¹⁵N-labeled compound having the alpha-primary amine or alpha-secondary amine is:

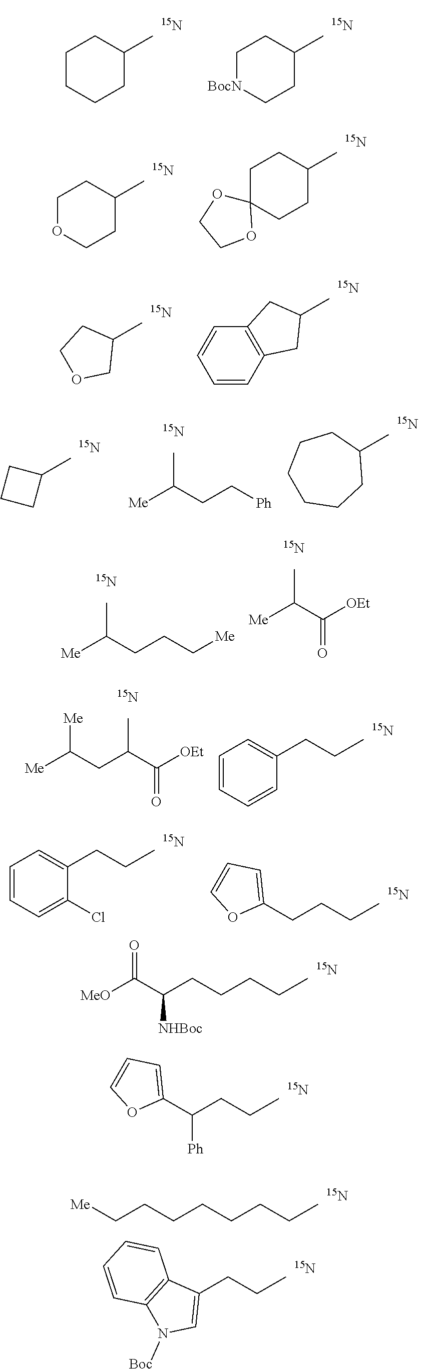

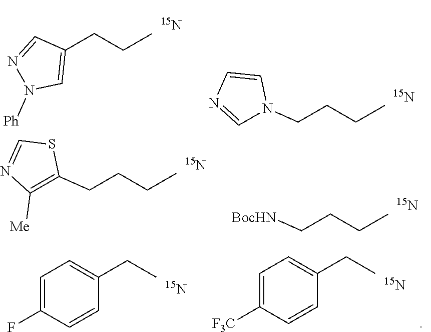

17. The method of claim 10, wherein the alpha-primary amine or alpha-secondary amine is a furan, indole, pyrazole, imidazole, thiazole or amino acid.

18. A method for producing a ¹⁵N-labeled compound having an alpha-primary or alpha-secondary amine comprising:
condensing an alpha-primary or alpha-secondary amine with a pyrilium salt to generate a Katritzky pyridinium salt;
mixing the Katritzky salt and a copper(I) catalyst containing a tetramethylheptanedianato (TMHD) ligand in the presence of a base to generate an electron-donor-acceptor complex, wherein the electron-donor-acceptor complex absorbs blue light;
fragmenting the electron-donor-acceptor complex to generate a primary or secondary radical and a Cu(II) species;
exchanging a ligand of the Cu(II) species with an ¹⁵N-labeled nucleophile and trapping the primary or secondary radical to generate a Cu(III) species; and
generating the ¹⁵N-labeled compound having the alpha-primary or alpha-secondary amine by reductive elimination of the Cu(III) species.

19. The method of claim 18, wherein the ¹⁵N-labeled nucleophile is ¹⁵N-labeled ammonium chloride.

20. The method of claim 18, wherein the base is cesium carbonate.
